(19) United States
(12) Patent Application Publication
(10) Pub. No.: US 2006/0094426 A1
(43) Pub. Date: May 4, 2006

(54) Wireless communication system and method

(76) Inventors: Ralph W. Donaho, Kent, TX (US); Christopher D. Wood, Arlington, VA (US)

Correspondence Address: WOOD, NGO & EISENBERG, PLLC, 2121 Eisenhower Ave, Suite 200, Alexandria, VA, 22314, US

(21) Appl. No.: 11/261,468

(22) Filed: Oct. 31, 2005

Related U.S. Application Data
(60) Provisional application No. 60/623,576, filed on Oct. 29, 2004.
(60) Provisional application No. 60/625,169, filed on Nov. 5, 2004.

(51) Int. Cl. H04Q 7/20

(52) U.S. Cl. 455/434

(57) ABSTRACT

A wireless communication system and method that can operate without relying on fixed infrastructure, such as fixed base stations and mobile terminal switching offices (MTSOs), of prior art cellular communication systems. In one embodiment of the invention, a SOWC protocol is used based on de novo creation of communication pathways (cps) to transfer messages between mobile terminals (MTs). In another embodiment, nearest neighbor methodology (NNM) is used to transfer messages between MTs. In a further embodiment, MTs comprise memory loaded with SOWC and/or NNM communication algorithms. In a further embodiment, SOCC and/or NNM enabled MTs are loaded with CDMA and/or GSM to enable MTs so equipped to operate independently of fixed infrastructure or in cooperation with fixed infrastructure such as fixed base stations.

### CROSS-REFERENCE TO RELATED APPLICATIONS

This application claims the benefit of priority from U.S. Provisional Patent Application Ser. No. 60/623,576 (filed Oct. 29, 2004) and 60/625,169 (filed Nov. 5, 2004). The Provisional Patent Applications 60/623,576 and 60/625,169 are incorporated by reference herein in their entirety.

### STATEMENT REGARDING FEDERALLY SPONSORED RESEARCH OR DEVELOPMENT

Not Applicable.

### FIELD OF THE INVENTION

This invention relates generally to wireless communication systems. The invention is a self-organizing wireless communication system and method that can operate without relying on fixed infrastructure, such as fixed base stations and mobile terminal switching offices (MTSOs), of prior art cellular communication systems.

### BACKGROUND OF THE INVENTION

Team activities sometimes give rise to dangerous situations in which human life can be at risk, e.g., firemen engaged in fighting a raging fire, members of a police tactical S.W.A.T. team entering and searching a large building, such as a large school, for one or more gunmen, a special forces team searching caves, or a rescue team spread out and searching an urban area lacking a viable cellular network, e.g., earth quake damaged infrastructure including base stations.

A review of the prior art follows.

A prior art cellular mobile telecommunications system includes a mobile station, such as a mobile cellular telephone, communicating with any one of a plurality of geographically fixed base stations. Broadly, each fixed base station defines a cell, and each cell forms an integral part of a larger cellular network. The size of a cell largely depends on the power rating of the corresponding base station. The base stations communicate with a mobile terminal switching office (“MTSO”) by means of intercellular trunk lines.

The MTSO determines which of the base stations and channels should process a call with the mobile station based on considerations such as signal strength between each available channel and the mobile station. The prior art cellular mobile telecommunication systems rely on fixed base stations. That is, a mobile terminal (MT) of the prior art such as a typical cell phone is limited to areas covered by fixed base stations. In other words, the prior art mobile terminal would not work in a country or region that lacks fixed base stations and/or access to a MTSO. In addition, the cellular systems of the prior art require mobile terminals to update their position relative to the closest base station by communication via a control channel in order to update the MTSO via the nearest base station or a base station within signal strength range of the mobile terminal, otherwise the MTSO is unable to route calls to the mobile terminal.

Even though mobile terminals such as cell phones utilize low-power transceivers, “camping” on control channels uses up battery power. A typical mobile terminal of the prior art requires a battery recharge every few days. Thus, there is a need for a cellular communication system that does not rely on fixed base stations. In addition, a considerable portion of the earth's surface lacks adequate cellular coverage. Thus, there is a need for a go-anyplace cellular communication system that can operate in areas that lack standard cellular services.

One way to determine the location of a mobile terminal uses the Cell of Origin. Specifically, in this location system, the mobile network base station cell area is used as the location of the mobile handset. The positioning accuracy achieved depends upon the cell size, which, if outside of urban areas, can be large. Thus, there is a need for a more accurate positioning system that is independent of cell size.

A more accurate way to determine the location of one or more mobile terminals (MTs), such as mobile cellular telephones, is the Time of Arrival (TOA) system. TOA is more accurate than Cell of Origin. TOA determines the mobile handset position by measuring the time of arrival of a handset signal to at least three network base stations, which must be synchronized. Such a system is described in U.S. Pat. No. 5,327,144. The system comprises a central site system operatively coupled to at least three cell sites. Each of the cell sites receives cellular telephone signals and integrate a timing signal common to all the cell sites. The central site calculates differences in times of arrival of the cellular telephone signals arriving among the cell sites and thereby calculates the positions of the cellular telephone producing the cellular telephone signals. The TOA and/or '144 system requires a considerable investment in, for example, fixed base stations. In geographical areas that lack fixed base stations, the TOA positioning system is void. Thus, there is a need for a positioning system that works without relying on fixed base stations and can work where the TOA positioning system is unavailable.

Another way of determining the position of a mobile terminal is the Enhanced Observed Time Difference (E-OTD) system, which operates in a similar way to the TOA system described above but improved timing measurements are made at the handset and at additional Location Measurement Units. An example of an E-OTD system is the Cambridge Positioning Systems (CPS) Cursor™ system. Again, the E-OTD system is dependent on a fixed base station set up. Thus, there is a need for a positioning system that works without relying on fixed base stations and can work where the E-OTD positioning system is unavailable.

Still another way of determining the position of mobile terminals, such as cell phones, rely on GPS satellite navigation. This system works by incorporating a GPS receiver within the cell phone. The position accuracy of this system can be high and may be higher still if the European-funded Galileo GPS project is deployed. However, position information is then typically communicated to other sites via cellular infrastructure including fixed base stations. GPS-equipped mobile terminals, such as cell phones fitted with GPS receivers, still rely on fixed base stations to communicate position information to a remote location. Thus, there remains the need for a system to communicate position information that does not rely on fixed base stations.

CB radios do not require fixed base stations and do not communicate via control channels to a MTSO or its equivalent. However, CB radios typically transmit at 4 watts and therefore require relatively large capacity batteries or access to a continuous power supply, such as a vehicle's battery. For example, CB radios may be fitted to a truck and draw power from the truck. In addition, while CB radios have more powerful transmitters than mobile terminals used in prior art cellular communication systems, CB radios remain limited in their effective broadcast range. The limited range of prior art CB radios springs from their inability to create and communicate through a cellular network of CB radios. Thus, there remains a need for mobile terminals adapted to form cellular networks for relaying information without relying on fixed base stations.

U.S. Patent Publication No. 20030151506, published Aug. 14, 2003 to M. Luccketti, describes a system (“the Luccketti '506 system”) for locating a person such as a child. The Luccketti '506 system includes a mobile transmitter removably secured to the person and a portable monitoring unit carried by a user, such as a parent monitoring, the location of the person. The mobile transmitter receives GPS ranging signals from GPS satellites. Each of the GPS ranging signals includes an offset proportional to the distance of the mobile transmitter from the respective GPS satellite broadcasting the GPS ranging signal. The GPS ranging signals, including the respective offsets, are transmitted to the portable monitoring unit. The portable monitoring unit comprises a GPS circuit that determines the location of the mobile transmitter based on the GPS ranging signals received by the mobile transmitter, and superimposes the location of the mobile transmitter on a map displayed on the portable monitoring unit.

The Luccketti '506 system does not include a GPS receiver/circuit in the remote device worn by the child. Thus, the Luccketti '506 system must stay in range of the remote device worn by the child or must otherwise rely on, if available, a separate cellular network made up of fixed base stations. Thus, if the '506 monitoring unit is too distant from the remote device to receive ranging signals, then the monitoring unit is at the mercy of the local cellular network, which if unavailable will render the Luccketti '506 system defunct. Thus, there is a need for a position monitoring system that can operate independently of a local or national independent cellular network and work in geographical areas or countries that lack a reliable cellular network.

U.S. Pat. No. 6,414,629, issued Jul. 2, 2002 to A. J. Curcio, describes a tracking system (“the Curcio '629 system”) The Curcio '629 system includes a remote unit with a processor to calculate the optimum time to transmit a position signal to a position-monitoring unit. The position-monitoring unit has a process that calculates a confidence level indicating the reliability of the position signal sent by the remote unit to the position-monitoring unit. The usefulness of the Curcio '629 system is undermined somewhat when the position monitoring unit is out of range of the remote unit. Thus, there is a need for a more robust position and tracking system.

U.S. Patent Publication No. 20010029430, published Oct. 11, 2001 to Y. Tamura, describes a positional information display system for a portable terminal device, in particular, a portable telephone. The portable device includes: a position-detecting unit that determines the operator's position based on GPS signals; an orientation detecting unit that uses a magnetic sensor or geomagnetic sensor; an arithmetically operating unit for correcting positional information; a map information storing unit for storing map information; and a display unit for displaying the present position of the operator on a map. The position and forward moving direction of the operator are displayed on the map. The Tamura '430 device is designed to compensate for likely position calculation errors and display position information on the display system in a user-friendly manner. The '430 patent does not teach or suggest the subject of the present invention. For example, the '430 patent does not teach or suggest a method of communicating position information to a remote display system via a wireless daisy chain as claimed in the present invention.

U.S. Pat. No. 6,654,681, issued Nov. 25, 2003 to Kiendle et al., describes a method for dynamically obtaining relevant traffic information and/or for dynamically optimizing a route followed by a vehicle. The '681 patent does not teach or suggest a dynamic cellular communication of the present system. For example, the '681 patent does not teach or suggest setting up and updating a communication pathway to transfer information between mobile stations as described and claimed in the present application. Neither does the '681 patent teach or suggest a method of conserving battery power as described and claimed in the present application.

None of the above patents, taken either singly or in combination, is seen to describe the instant invention as claimed.

### SUMMARY OF THE INVENTION

A wireless communication system and method that can operate without relying on fixed infrastructure, such as fixed base stations and mobile terminal switching offices (MTSOs), of prior art cellular communication systems. In one embodiment of the invention, a SOWC protocol is used based on de novo creation of communication pathways (cps) to transfer messages between mobile terminals (MTs). In another embodiment, nearest neighbor methodology (NNM) is used to transfer messages between MTs. In a further embodiment, MTs comprise memory loaded with SOWC and/or NNM communication algorithms. In a further embodiment, SOCC and/or NNM enabled MTs are loaded with CDMA and/or GSM to enable MTs so equipped to operate independently of fixed infrastructure or in cooperation with fixed infrastructure such as fixed base stations.

### BRIEF DESCRIPTION OF THE DRAWINGS

FIG. 1 shows a mobile terminal (MT) according to one aspect of the present invention.

FIG. 2 shows a mobile terminal according to one aspect of the present invention.

FIG. 3 shows a mobile terminal according to one aspect of the present invention.

FIG. 4 shows a mobile terminal according to one aspect of the present invention.

FIG. 5A shows a mobile terminal according to one aspect of the present invention.

FIG. 5B shows a flow chart depicting mobile terminals switching between SOCC and prior art cell telecom infrastructure.

FIG. 6 shows a mobile terminal according to one aspect of the present invention.

FIG. 7 shows a mobile terminal according to one aspect of the present invention.

FIG. 8 shows a mobile terminal according to one aspect of the present invention.

FIG. 9 shows a mobile terminal according to one aspect of the present invention.

FIG. 10A shows a mobile terminal according to one aspect of the present invention.

FIG. 10B shows a mobile terminal according to one aspect of the present invention.

FIG. 11 shows a mobile terminal according to one aspect of the present invention.

FIG. 12 shows a mobile terminal according to one aspect of the present invention.

FIG. 13 shows a mobile terminal according to one aspect of the present invention.

FIG. 14 shows the relative positions of a first plurality of team members 360.

FIG. 15 shows the possible two-way wireless communications between MTs of FIG. 14.

FIG. 16 shows actual two-way wireless communications between MTs of FIG. 15.

FIGS. 17-25 show a non-limiting example of the SOCC based wireless communication protocol of the present invention in action.

FIG. 26 shows the physical layout of MTs 120: MT#1 through to MT#12 (referred to collectively as team or group 590, see TABLE 4).

FIG. 27 shows how an NN list is be compiled with respect to each NNM enabled MT 120 of group 590.

FIG. 28 shows a flow chart depicting the logic steps for flushing an NN list of an MT according to the invention.

FIG. 29 shows a flow chart depicting the logic steps for setting a nearest neighbor flag (NNF_{N})

FIGS. 30-36 show a non-limiting example of the NNM based wireless communication protocol of the present invention in action.

### DETAILED DESCRIPTION OF THE PREFERRED EMBODIMENTS

This invention relates generally to wireless communication systems. The invention is a self-organizing wireless communication system and method that can operate without relying on fixed infrastructure, such as fixed base stations and mobile terminal switching offices (MTSOs), of prior art cellular communication systems.

In one embodiment, the invention is a self-organizing wireless communication system (referred to in the parent provisional patent applications as a self-organizing cellular communication (SOCC) system 100) and methodology to relay information between local and remote mobile terminals (MTs) capable of operating without relying on fixed infrastructure, such as fixed base stations and mobile terminal switching offices (MTSOs), of prior art cellular communication systems. In the first embodiment, the MTs act as roving base stations, wherein each roving base station creates a roving cell. The SOCC system and methodology allows automatic wireless communication between MTs with non-overlapping cells, e.g., a first SOCC enabled MT defines a first roving cell, and a second SOCC enabled MT defines a second roving cell, wherein the first and second roving cells do not overlap. Wireless communication between the first and second SOCC enabled MTs is rendered possible under the SOCC system and methodology, which sua sponte creates a wireless communication pathway (“cp”) based on overlapping cells between MTs located between the first and second MTs. Each SOCC enabled MT acts like a roving base station, and the SOCC logic ensures that messages are transferred between selected MTs.

In another embodiment, a wireless communication system uses nearest-neighbor methodology (“NNM”). NNM allows wireless communication networks to be created sua sponte (Latin for “on its own will or motion”) in real time. This non-obvious and novel method of wireless communication turns NNM enabled MTs into autonomous roving base stations able to wirelessly communicate requests and information over an NNM enabled network, with no requirement of fixed base stations or MTSOs required in traditional wireless cellular communication systems.

The numeric label “120” is used in the accompanying FIGURES to generally denote MTs of the present invention. The MTs 120 of the present invention can be SOCC and/or NNM enabled MTs. SOCC and/or NNM enabled MTs 120 may also be enabled to run prior art CDMA, WCDMA, and GSM, alone or in combination.

It should also be understood that the term “mobile terminal” (MT), as used in the context of the invention, applies to any wireless mobile device that can be carried by a human and is enabled to run SOCC and/or NNM communication protocols of the present invention. The present invention is intended to cover SOCC and/or NNM enabled cell phones, which can work in a conventional setting with conventional fixed base stations in operable communication with an MTSO (mobile terminal switching office), or in an area that lacks fixed base stations. For example, an MT of the present invention can take the form of SOCC and/or NNM enabled personal digital assistant (PDA).

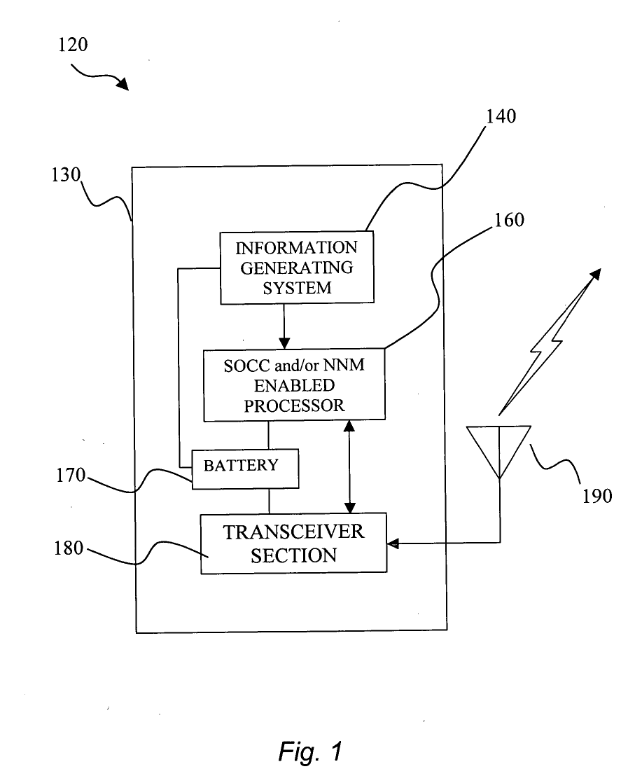

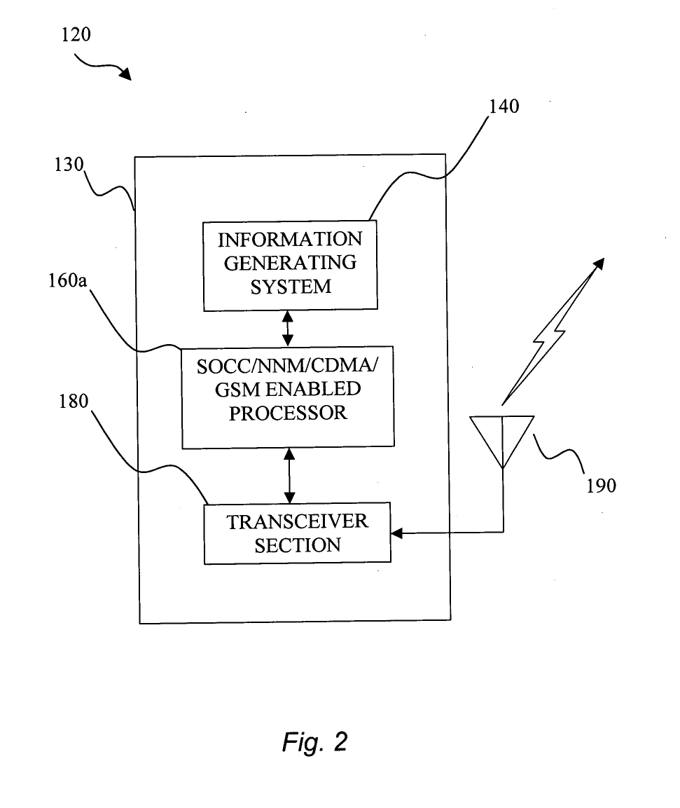

FIGS. 1 and 2 show a mobile terminal 120 suitable for use in the present invention. The MT 120 comprises a housing 130, an optional information generating system (IGS) 140, a processor 160, a power source such as a battery 170 (shown in FIG. 1), and a transceiver section 180 operably coupled to communication antenna 190.

Still referring to FIGS. 1 and 2, processor 160 may be any known MT communication controller comprising an integrated circuit including a process unit. The processor 160 either includes on-chip memory or is operably connected with memory. The memory may include random access memory (RAM), read only memory (ROM), erasable programmable ROM (EPROM) and a data storage memory. The memory stores operational software code including code that renders the processor 160 able to perform SOCC and or NNM type functions, see Working Examples #1 and #2, respectively. The operational software code stored in memory is read and processed by the processor 160 to enable the processor 160 to process data received from the information generating system 140 (IGS 140) and oversee the operation of the transceiver section 180.

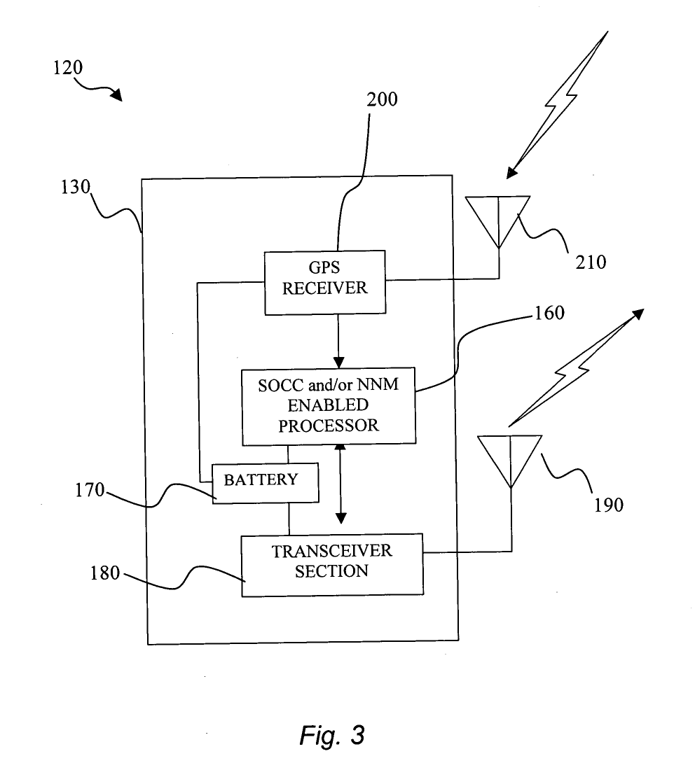

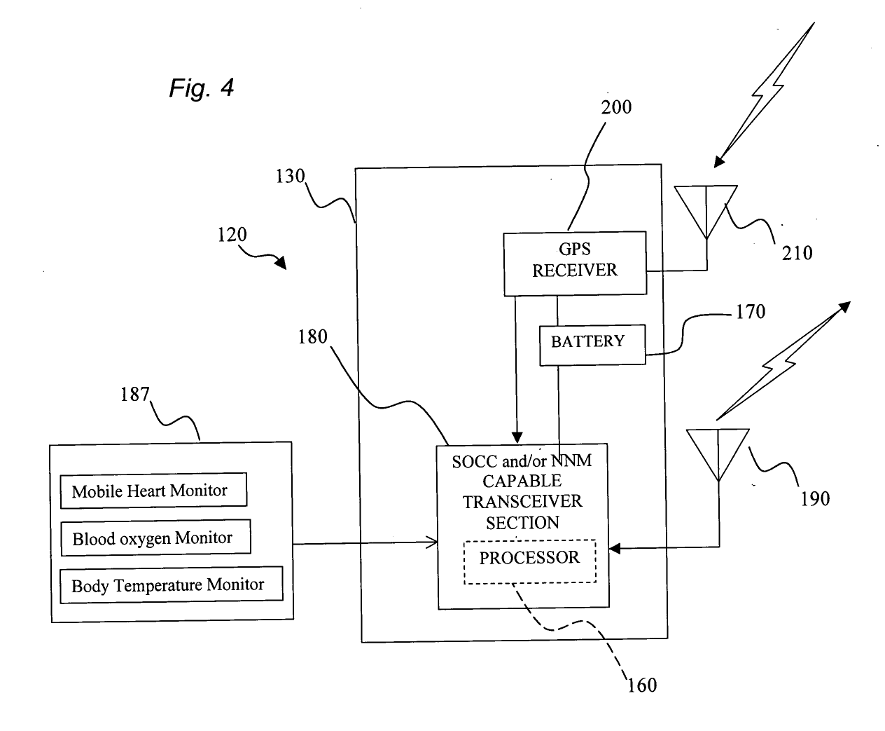

The IGS 140 can take various forms. For example, the IGS 140 can take the form of a GPS receiver 200 alone as shown in FIG. 3. Alternatively, IGS 140 can take the form of a GPS receiver 200 in combination with another information gathering device, such as a bio-monitor 187 for monitoring, e.g., heart rate (see FIG. 4), wherein the bio-monitor is adapted to provide data to the MT 120. The bio-monitor can be any bio-monitor easily carried by an average person, such as, but not limited to, a pulse oximeter. For example, the CheckMate® Pulse Oximeter (Product code: VEN-0047, available from SPO Medical Inc., 21860 Burbank Blvd., North Building, Suite 380, Warner Gateway, Woodlands Hills, Calif. 91367, U.S.A.).

Bio-monitor 187 would, for example, provide a chemo-defense or biohazard defense team a layer of early warning, such that if a team member was overcome, the processor 160 could be programmed to send an alert via transceiver 180 to other MTs 120 via the SOCC 100 (and/or NNM 590) based MTs 120. Terrorists in the form of al-Qaeda operatives present a clear and present danger, one that the present invention is designed to help counter.

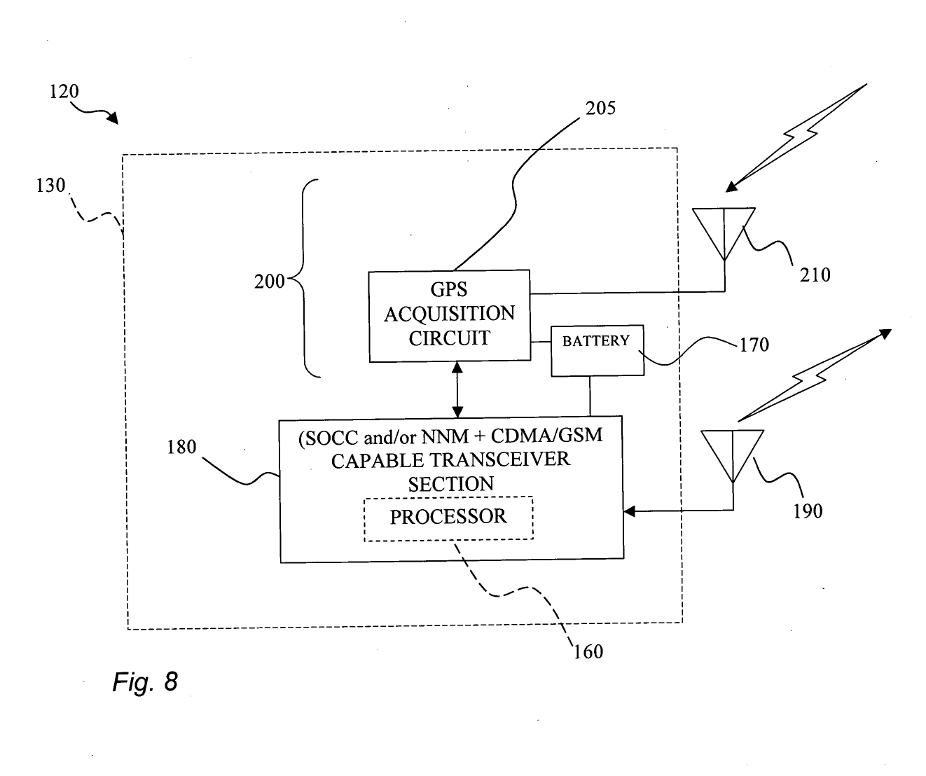

It should be understood that various levels of integration could be applied. For example, the processor 160 can be integrated into, or considered part of, the transceiver section 180 (see, e.g., FIG. 8) without detracting from the scope or spirit of the present invention. It should also be understood that the term “local MTs”, as used in the context of the invention, applies to MTs that are within radio frequency (RF) transceiver range of at least one other SOCC capable MT. It should be understood that the term “remote MTs”, as used in the context of the invention, applies to MTs that are out of RF transceiver range of another SOCC capable MT.

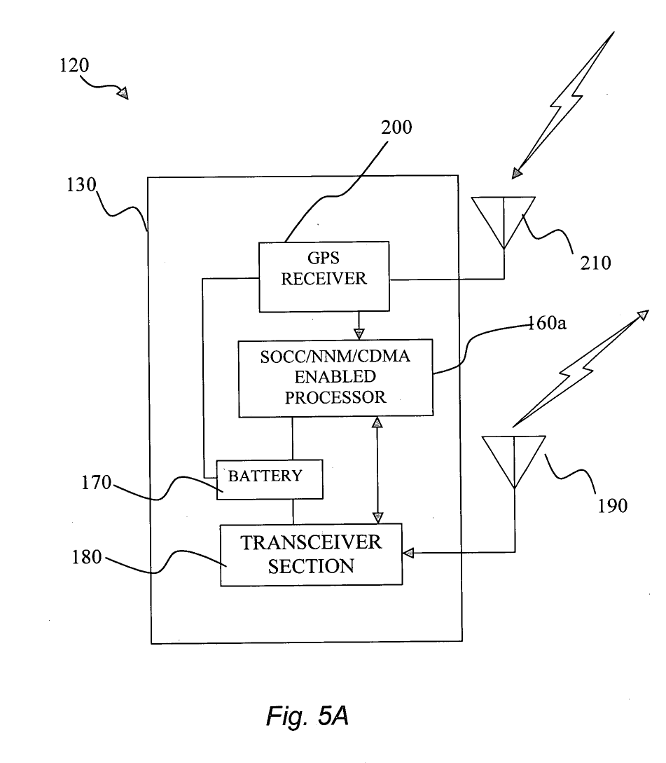

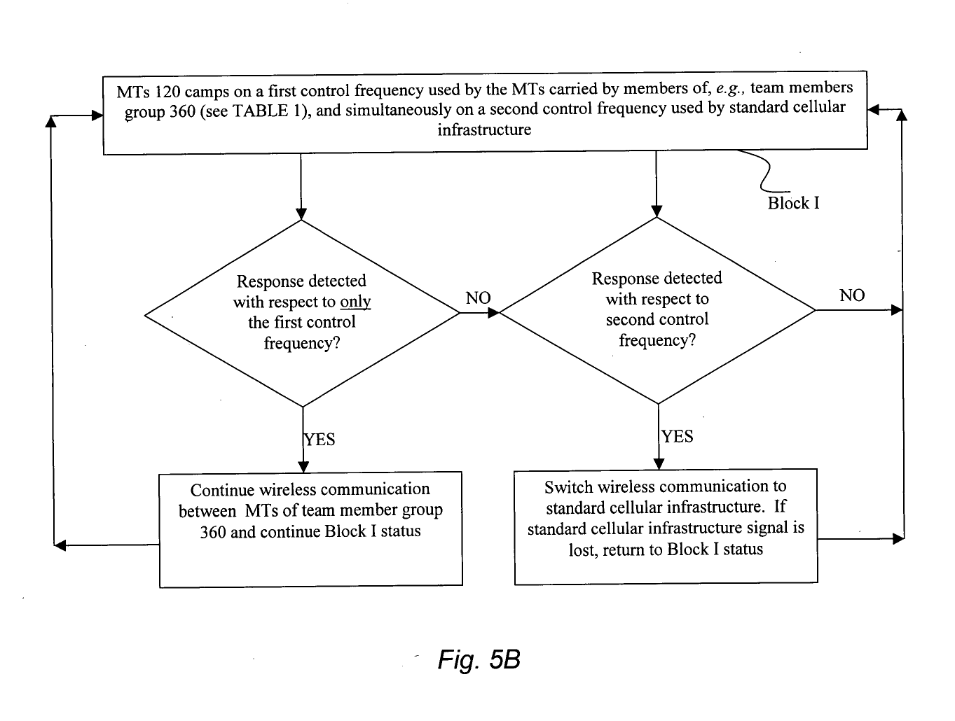

MT 120 optionally comprises a CDMA and/or GSM compliant transceiver section 180 thereby allowing MT 120 to both communicate with other MTs 120 using the SOCC protocol 100 and, when desired, communicate with a CDMA (Code Division Multiple Access) or GSM (Global System for Mobile Communication) cellular telephone system comprising, for example, of fixed base stations. It should be understood that Qualcomm WCDMA technology can also be used in conjunction with the SOCC and/or NNM based technology of the present invention. A schematic of a CDMA/GSM compliant MT 120 that includes a SOCC/CDMA enabled processor 160a is shown in FIG. 5A. An MT of the present invention can switch, for example, between SOCC/NNM and a traditional cellular network as shown in FIG. 5B. The MTs 120 may perform such switching tasks in parallel fashion as shown in FIG. 5B, but it should be understood that the same logic steps can be performed in a serial fashion.

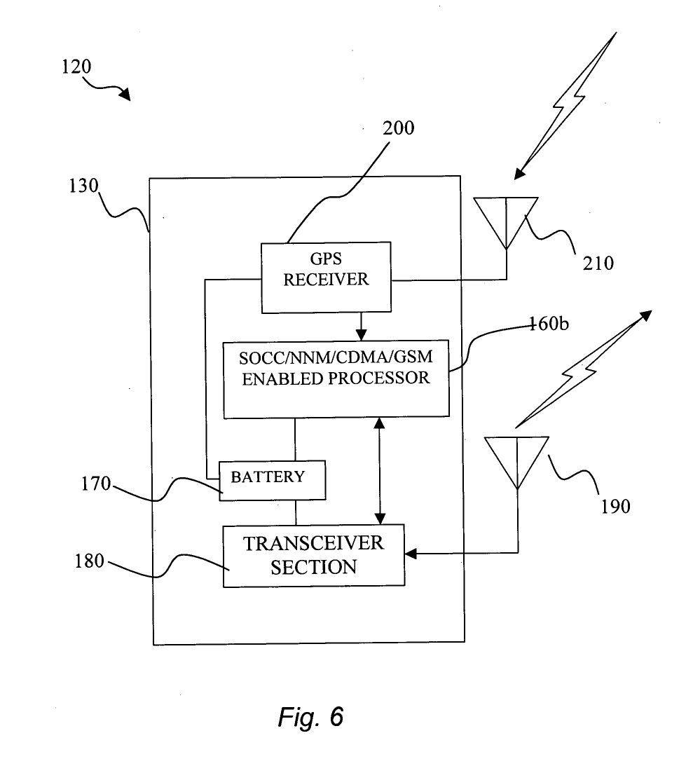

FIG. 6 shows a mobile terminal 120 that includes a SOCC/CDMA/GSM enabled processor 160b. Thus, MT 120 optionally comprises a SOCC, CDMA and/or GSM compliant transceiver section 180 thereby allowing MT 120 to both communicate with other MTs 120 using the SOCC protocol 100 and, when desired, communicate with a CDMA (Code Division Multiple Access) or GSM (Global System for Mobile Communication) cellular telephone system comprising, for example, of fixed base stations.

Processor 160 contains memory, or is operably linked to memory, such that the processor can perform the logic steps necessary to wirelessly communicate under the SOCC protocol 100. Information, such as position information, processed by information generating system 140 is relayed to processor 160 and transmitted, as appropriate, via transceiver section 180 under the SOCC protocol 100. However, as discussed above, MT 120 optionally comprises a CDMA and/or GSM compliant transceiver section 180 thereby allowing MT 120 to both communicate with other MTs 120 using the SOCC protocol 100 and, when desired, communicate with a CDMA (Code Division Multiple Access) or GSM (Global System for Mobile Communication) cellular telephone system comprising, for example, of fixed base stations. A schematic of a CDMA/GSM compliant MT 120 is shown in FIG. 5A.

While MTs having a GPS receiver combined with a communication system capable of communicating with a base station are known (e.g., U.S. Pat. No. 5,945,944 describes such a device), the prior art does not teach a MT having SOCC 100 capability. U.S. Pat. No. 5,945,944, issued Aug. 31, 1999 to N. F. Krasner is herein incorporated by reference in its entirety.

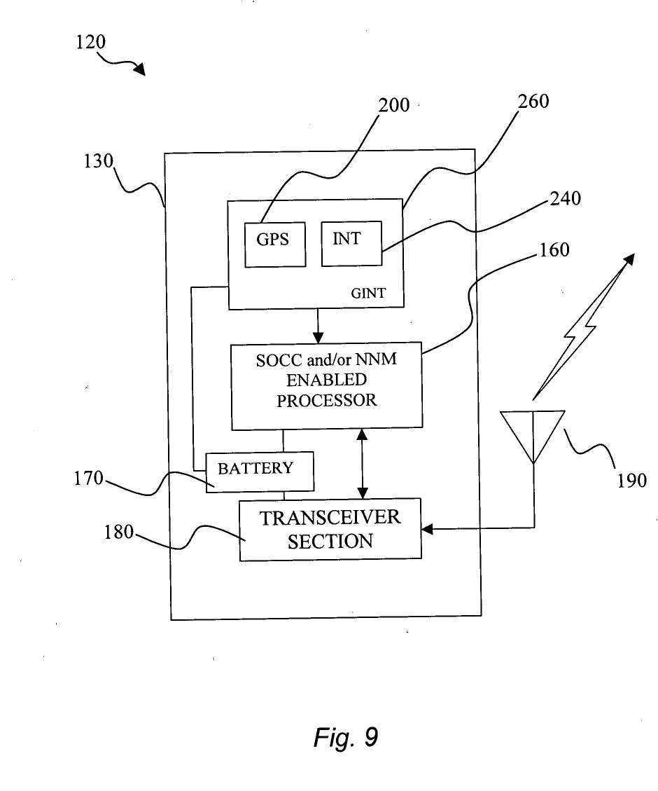

In another embodiment, the information generating system 140 is a GPS receiver 200 in combination with inertial tracker/navigation module (INT) 240 (see FIG. 9) to form a combined GPS/Inertial-navigation-tracker (GINT) 260. GINT 260 can help in circumstances where the MT 120 is unable to receive or otherwise process GPS satellite signals. MT 120 with INT 240 offsets this problem. For example, GPS receiver 200 and INT 240 run simultaneously such that if a problem occurs in GPS receiver 200, then INT 240 provides position updates to processor 160. Alternatively, GPS receiver 200 and INT 240 work cooperatively such that output from INT 240 is used to improve or complement data supplied by GPS receiver 200.

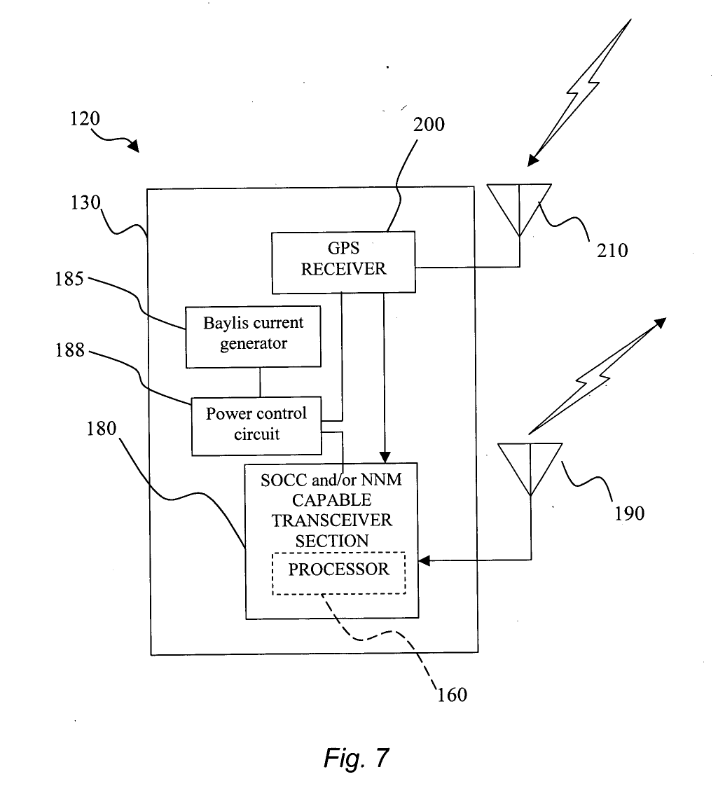

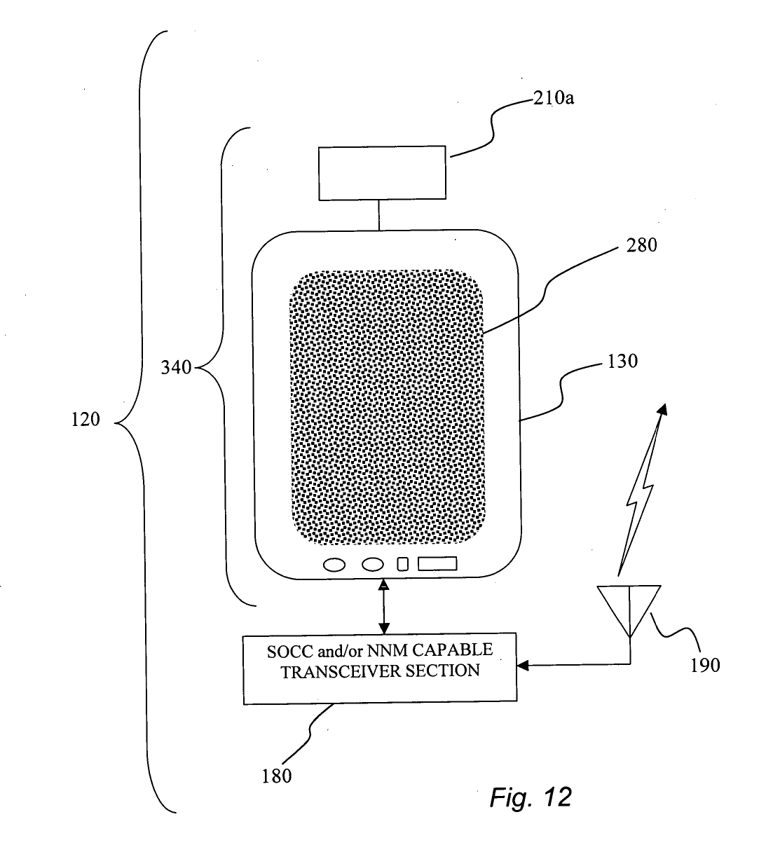

It should be understood that various components might be placed outside or on the housing 130. For example, the transceiver section 180 (and derivatives thereof, see, e.g., FIG. 12) can be located outside the housing 130. In addition, the battery 170 may be located on or external with respect to the housing 130. Also, there may be redundancy built into the MT 120 apparatus, such as, there may be more than one battery 170. Alternatively, the battery may be replaced entirely by a wind up or spring based electricity generator such as that used to power the Trevor Baylis clockwork radio (described in U.S. Pat. No. 5,917,310, issued Jun. 29, 1999) or a wind up powered torch. Such electrical generators are useful, for example, when batteries are run down/discharged or otherwise rendered useless. Numeric labels 185 and 188 in FIG. 7 respectively represent the Baylis current generator and power control circuit. The Baylis '310 patent is herein incorporated by reference in its entirety.

The battery 170 may be replaced or supplemented by a piezoelectric power source. For example, piezoelectric materials can be incorporated into the soles of a shoe or boot to generate a flow of electrons on each heel strike during walking such as that described in U.S. Pat. No. 4,870,700, issued Sep. 26, 1989 to Ormanns, et al. The piezoelectric material can be coupled into a suitable circuit to power the MT 120, such as the processor 160, transceiver 180, and a GPS receiver 200, alone or in combination. The Ormanns, et al. '700 patent is incorporated herein by reference in its entirety.

The dimensions of the information generating system 140 can vary but are preferably under 5 cm in any direction. This is eminently feasible in light of modern day miniaturization. For example, the GPS receiver 200 can comprise a high-gain small sized low power receiver such as the GeoHelix-H. The GeoHelix-H measures 30.4×13.3×6.4 millimeters and weighs about 12 grams. The GeoHelix-H operates over the L1 GPS band and has an integral low noise amplifier (LNA) providing a typical gain of about 20 dB, omni-directional pattern, and 3 dB beam width of about 120 degrees, and is available from Sarantel Ltd., Unit 2, Wendei Point Ryle Drive, Park Farm South, Wellingborough, Northants, NN8 6AQ, England, UK. The GPS receiver 200 can comprise a single-chip GPS receiver, such as the SE4100 GPS Radio IC from SiGe Semiconductor, which integrates the IF filter, VCO, tank circuitry and LNA into a compact 4 mm square package with a current drain of only about 10 mA from a 2.7 Volt supply.

GPS receiver 200 is preferably not affected by close proximity to human tissue. The GeoHelix-H has a low field, which is not easily detuned when in close proximity to body tissue. Also, the omni-directional pattern along with a 3 dB beam width of about 120 degrees enables more GPS satellites to be “seen” by the GeoHelix-H antenna than with a patch antenna. However, the present invention does not exclude the use of the patch antennae for receiving GPS signals. For example, the MT 120 may take the form of a personal digital assistant (PDA) such as the Garmin iQue 3600 GPS/PDA (represented by part number 340 in FIG. 12) with Palm 5 OS® fitted with an integrated flip-up GPS patch antennae (represented by part number 210a in FIG. 12) operably linked to transceiver section 180, and software to run the cellular communication (SOCC) protocol 100. The iQue 3600 is a consumer GPS/PDA product supplied by Garmin Ltd. (NASDAQ: GRMN)

The iQue 3600 is a PDA integrated with GPS technology packed into housing of just 2.8″ W×5″ H×0.8″ D (72×128×20.3 mm, respectively) and has a display screen 280. A person of ordinary skill in the art would understand that the iQue 3600 could be modified to render the unit SOCC capable. For example, combining the iQue 3600 with a SOCC capable transceiver section 180 would convert the iQue 3600 into an MT 120 according to the invention. A human user could use the MT 120 to communicate information directly to other MT 120 units. The iQue 3600 is fitted with a flip-up integrated GPS patch antenna (represented by the numeral label 210a in FIG. 12). Patch antennas are arguably inferior to helical antennas in acquiring GPS satellite signals. Perhaps in response to this problem, the position of the iQue 3600 patch antenna 210a can be varied to pick up GPS signals.

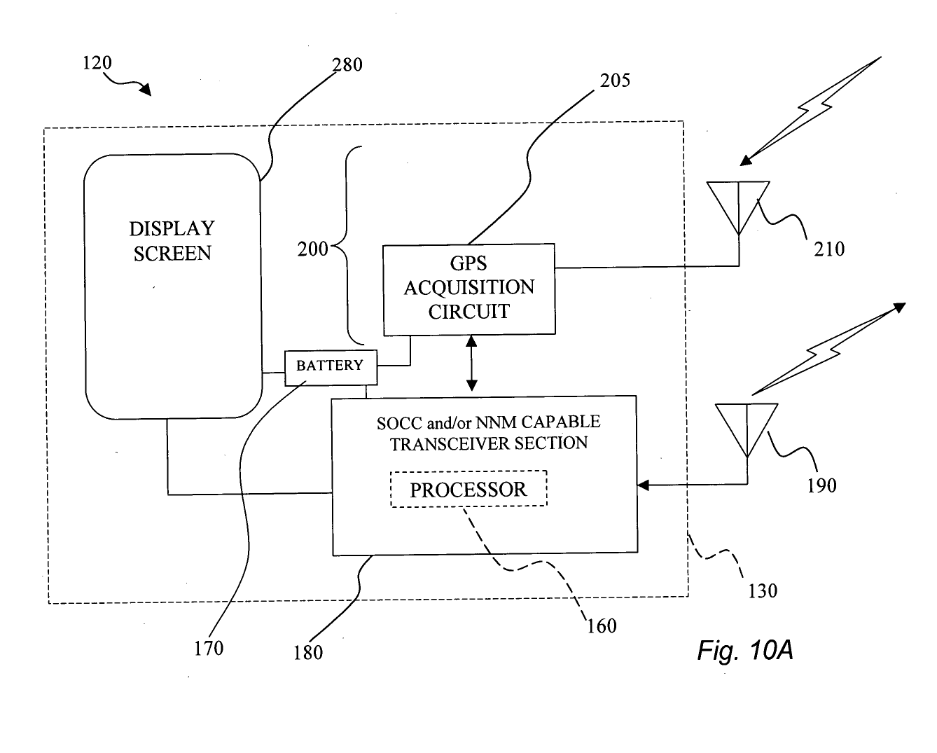

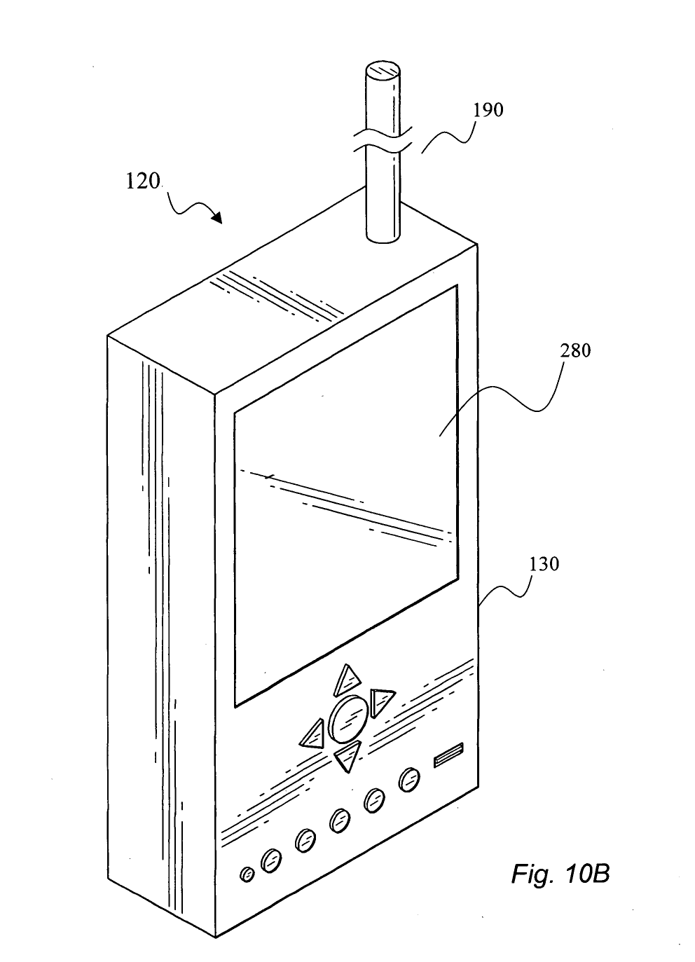

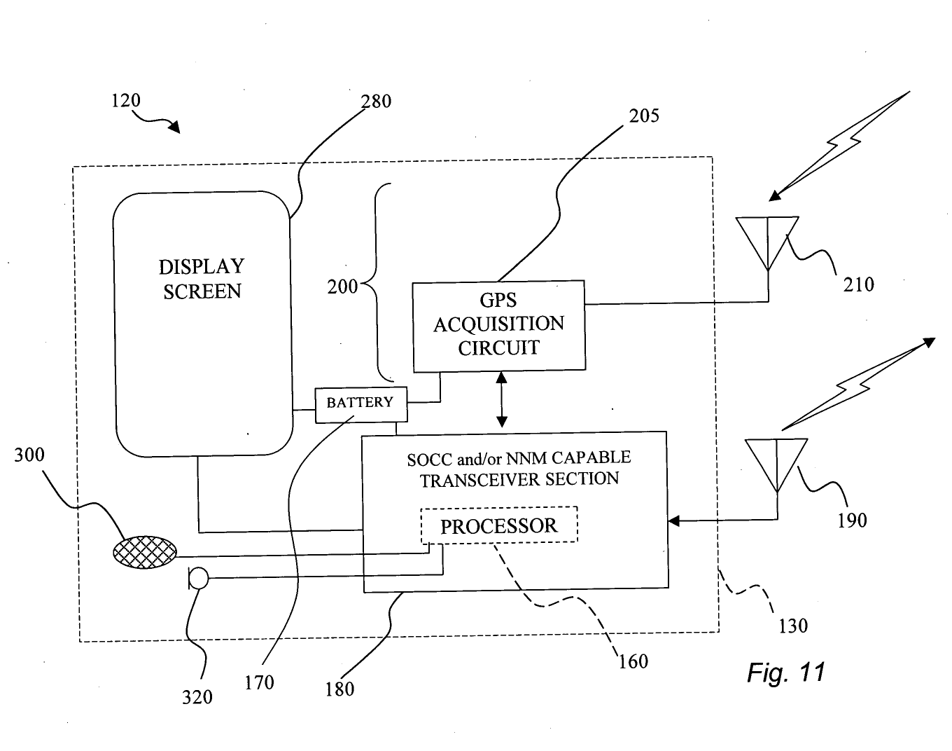

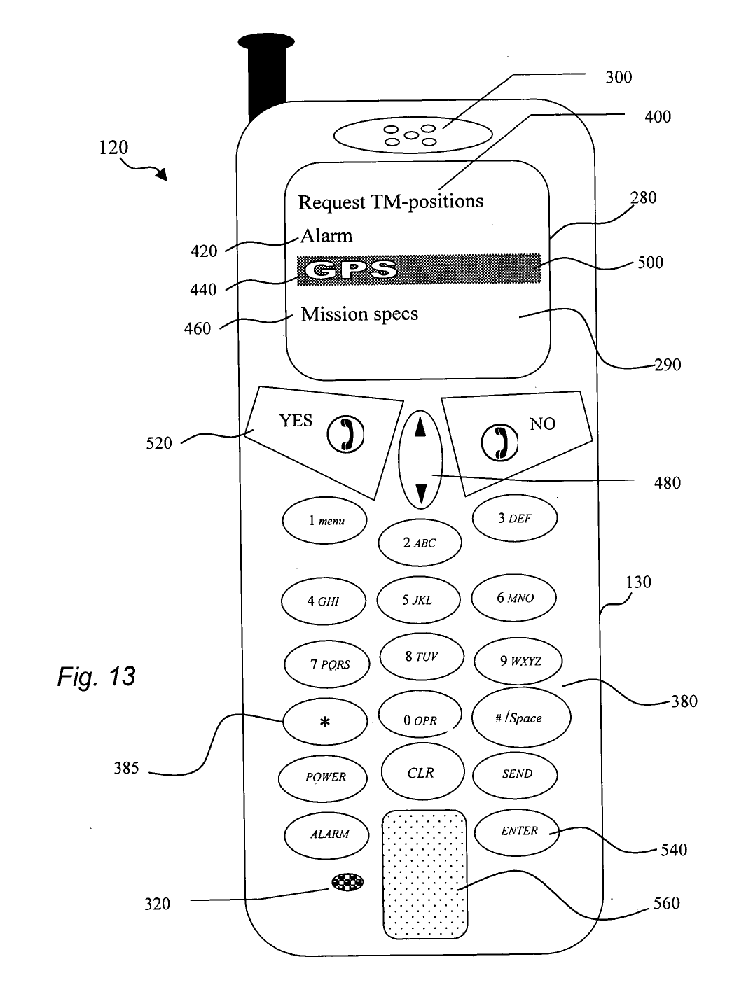

It will therefore be understood by the person of ordinary skill in the art that the MT 120 according to the present invention can take various forms without detracting from the spirit of the invention. The MT 120 includes an optional display screen 280 (different versions shown in FIGS. 10A, 10B, 12, and 13), optional speaker 300 and/or microphone 320 (see, e.g., FIGS. 11 and 13). Information can be displayed or outputted respectively via the optional screen 280 and/or speaker 300.

Referring to FIG. 13, a keypad 380 can be used to enter data into MT device 120. In this example, the keypad 380 comprises a plurality of buttons 385. The screen 280 can be formatted into a menu like icon display 290 with icons or menu selections such as, but not limited to, request for team member GPS positions 400, a general alarm selection 420, a GPS selection 440, and mission specific specs 460. An up-down toggle switch 480 can be used to make selections.

Icons can be preprogrammed and entered into the icon menu 290. For example, icon 400 can be regarded as a stored macro, which when selected automatically returns the GPS positions of every team member in team member group 360 (see below for explanation of “team member group 360”). Macros accessible via an icon in icon display 290 will save a legitimate user a lot of time by negating the need to press a lot of buttons 385 in keypad 380.

Still referring to FIG. 13, selections can be entered, for example, using the YES 520 or ENTER 540 selection buttons. An optional fingerprint reader 560 can be fitted to the MT device 120, operably linked to processor 160 and used to verify sensitive requests such as, for example, team member positions (icon selection 400) of other team members 360 (see below for a non-limiting description of a typical team member group 360).

Still referring to FIG. 13, the optional fingerprint reader 360 can be similar to the fingerprint reader fitted to IBM® ThinkPad® laptops, such as the ThinkPad T42 model. The fingerprint reader 560 can be used to prevent illicit use of the MT device 120 by unauthorized persons. It should be understood that the fingerprint reader 560 is not limited to solely reading finger prints, but can also read, for example, a person's thumbprint.

The INT module 240 (FIG. 9) preferably uses miniature gyroscopes and accelerometers, such as the so-called silicon gyroscopes and accelerometers, to determine the position and velocity vector of MT 120. Such gyroscopes and accelerometers are available from several suppliers including Analog Devices Inc. (ADI), such as the ADXL103 (a 5 mm×5 mm×2 mm LCC package), which is a high precision single axis accelerometer mounted on a single chip, and the ADXL213 supplied by ADI is a precision, low power, complete dual axis accelerometer with signal conditioned, duty cycle modulated outputs, on a single monolithic integrated chip (IC). Also, ADI's ADXL311 is a low cost, low power, complete dual axis accelerometer with signal conditioned voltage outputs, all on a single monolithic IC of dimensions of just 5 mm×5 mm×2 mm. In addition, ADI's ADXRS401 is a low-cost complete ultra small and light (<0.15 cc, <0.5 gram) angular rate-sensing gyroscope capable of measuring up to 75 degrees per second with all of the required electronics on a single chip.

Such miniature inertial kit is available and used, for example, by COMARCO, Inc. (and more particularly its subsidiary Comarco Wireless Technologies (CWT) of Irvine, Calif. 92618, USA). CWT miniature inertial modules are capable of precision position measurements in buildings and urban canyons and, when combined with a GPS receiver 200, can determine the position of MT 120 with a high degree of accuracy and reliability.

Papers describing micro-electromechanical system (MEMS) tracking/navigation technology (or their functional equivalent) are available through the well-known Draper Laboratory and more particularly its Draper Fellow Program, which has published numerous papers on MEMS technology. The Charles Stark Draper Laboratory, Inc. (Cambridge, Mass.) has developed miniature inertial sensors that cost 5 to 10 times less than conventional gyroscopes and accelerometers. Draper and Rockwell International (Anaheim, Calif.) have assembled these accelerometers and gyroscopes, along with processing electronics, into low-cost miniaturized inertial systems. These systems have dimensions of about 2×2×0.05 cm and have a low power requirement (about 1 milliwatt).

It should be understood that figures in the form of schematics (such as FIG. 9) should not be regarded as scale drawings. Schematics reveal operable arrangements of elements, some of which are optional, that make up MT device 120.

### WORKING EXAMPLE #1

### SOCC Protocol in Action

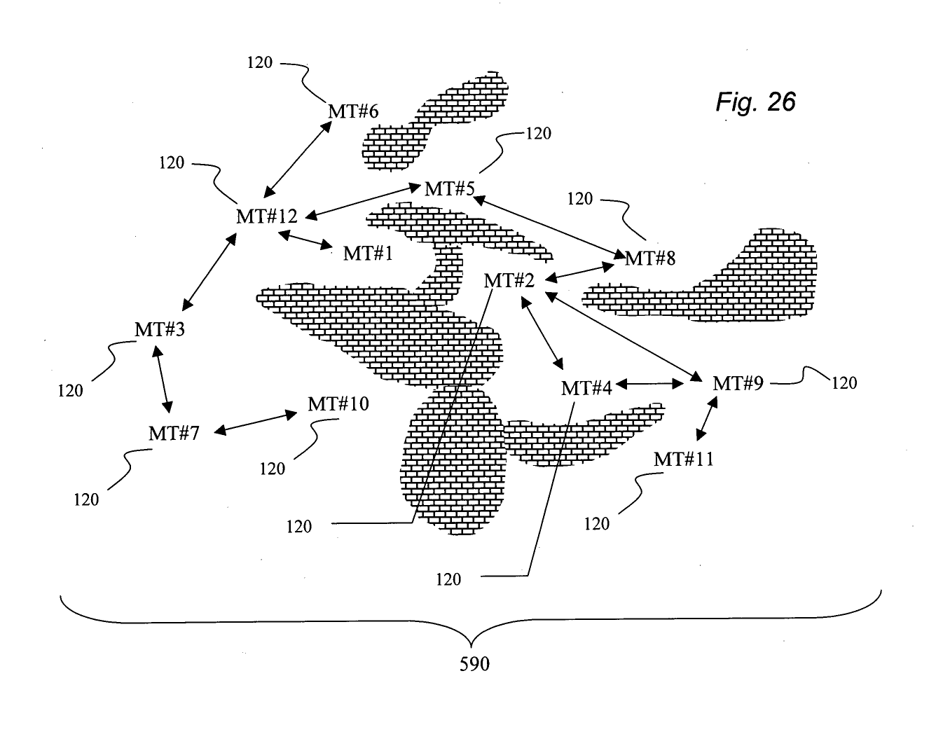

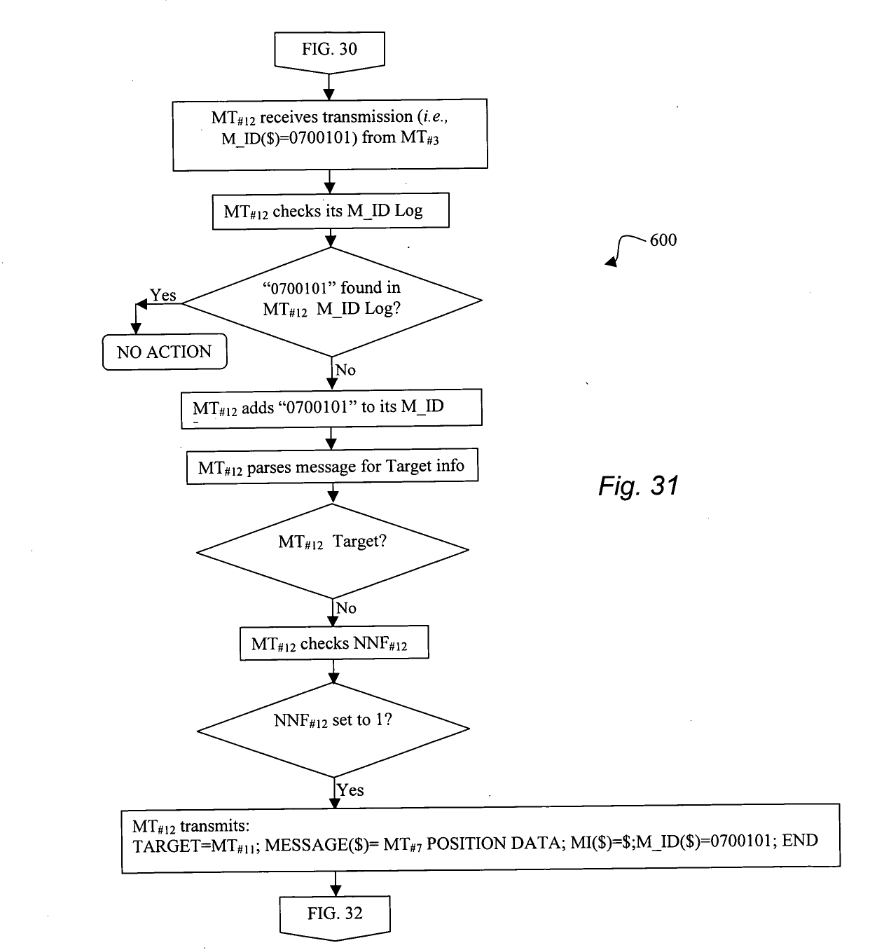

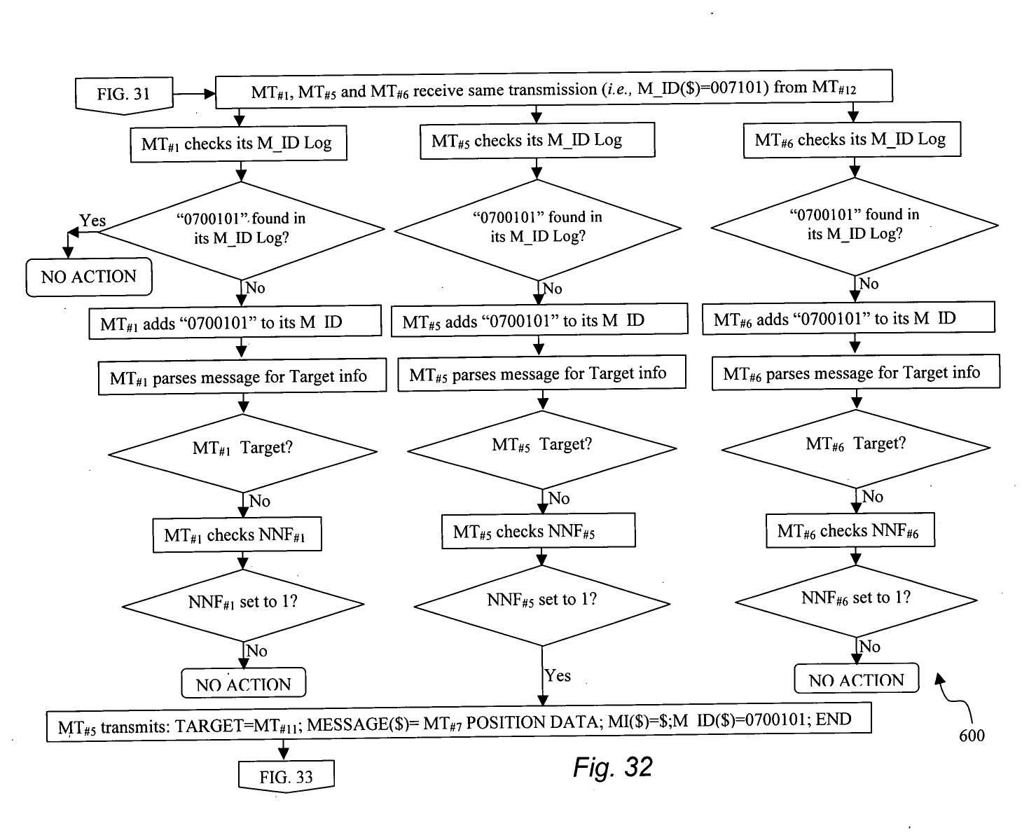

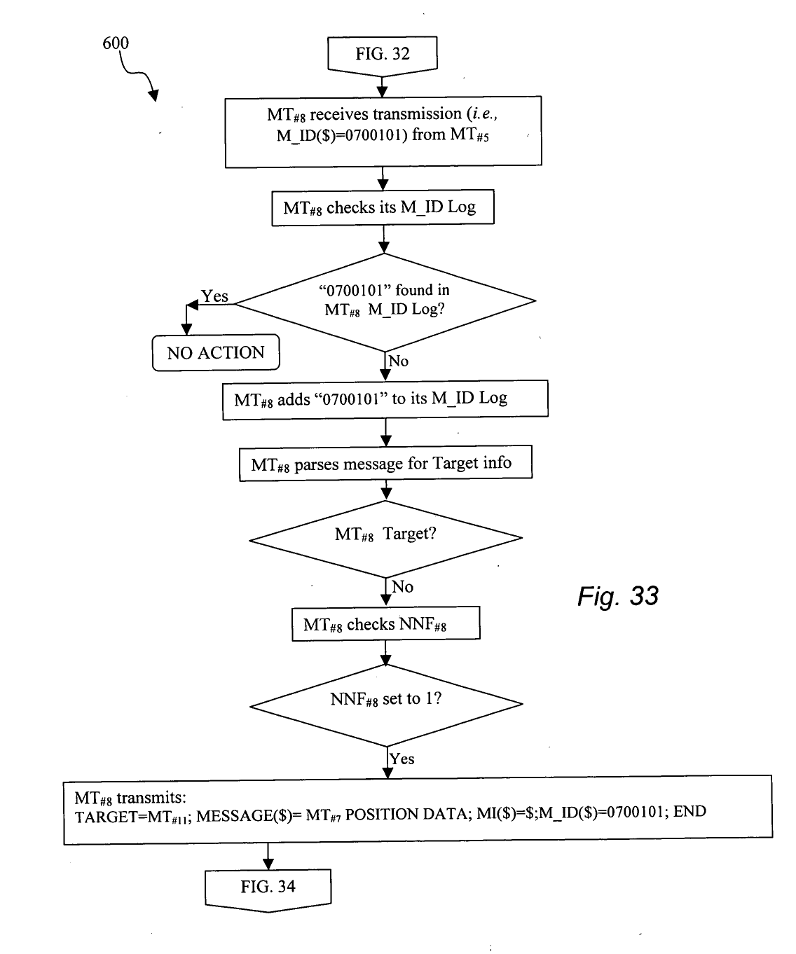

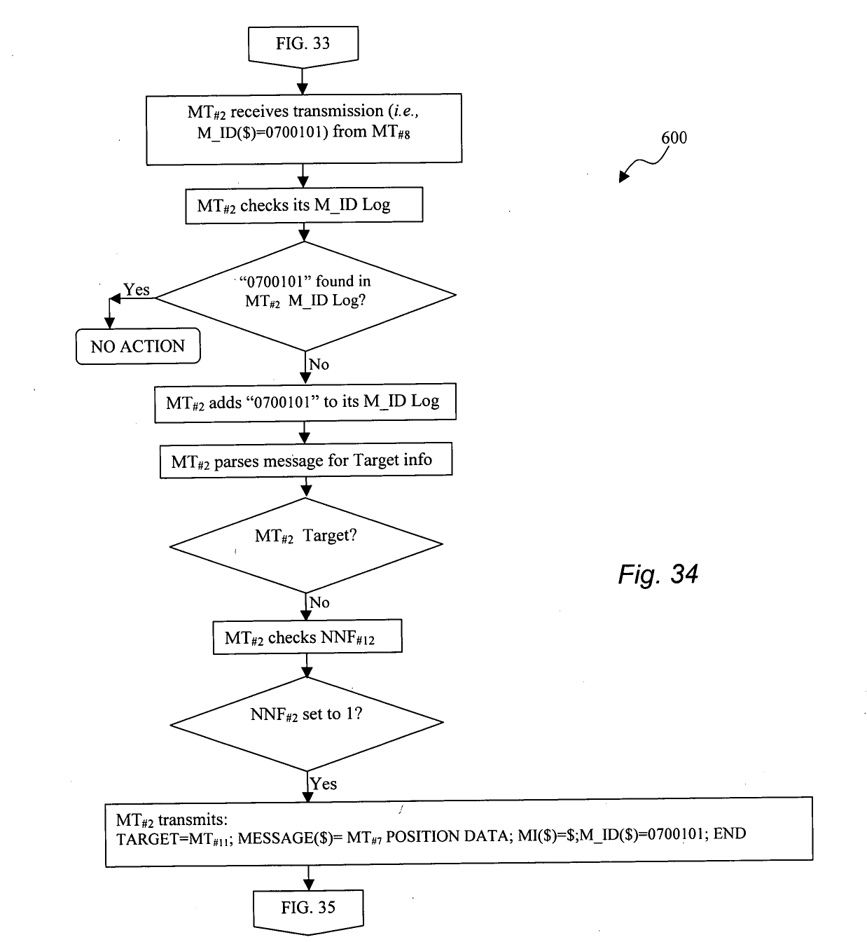

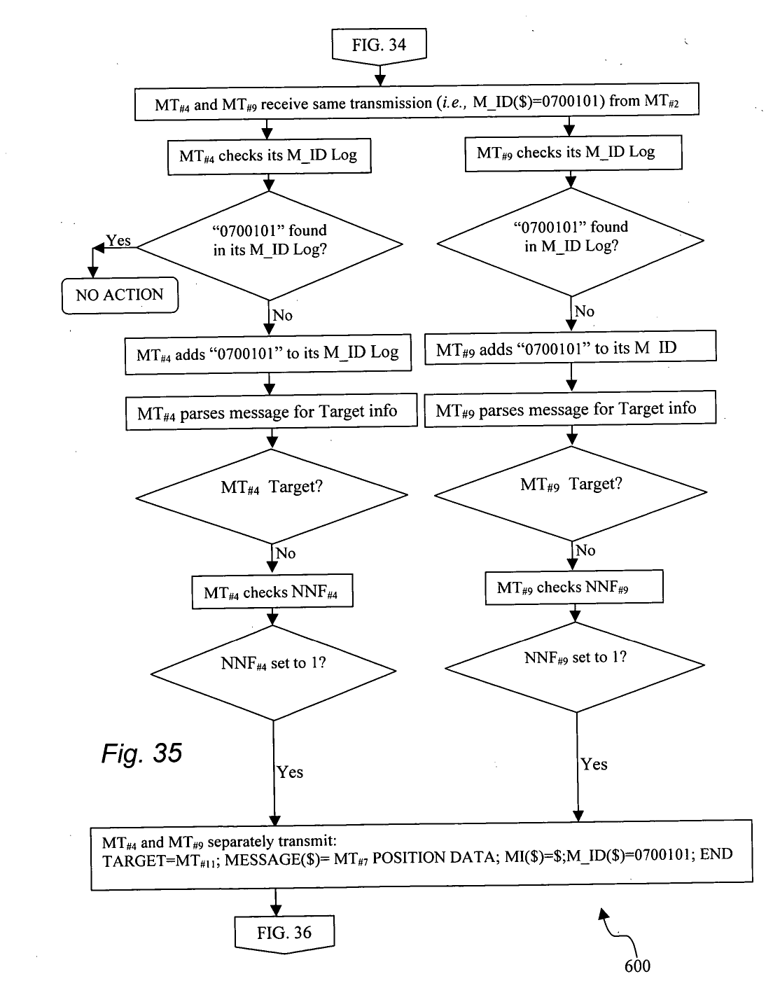

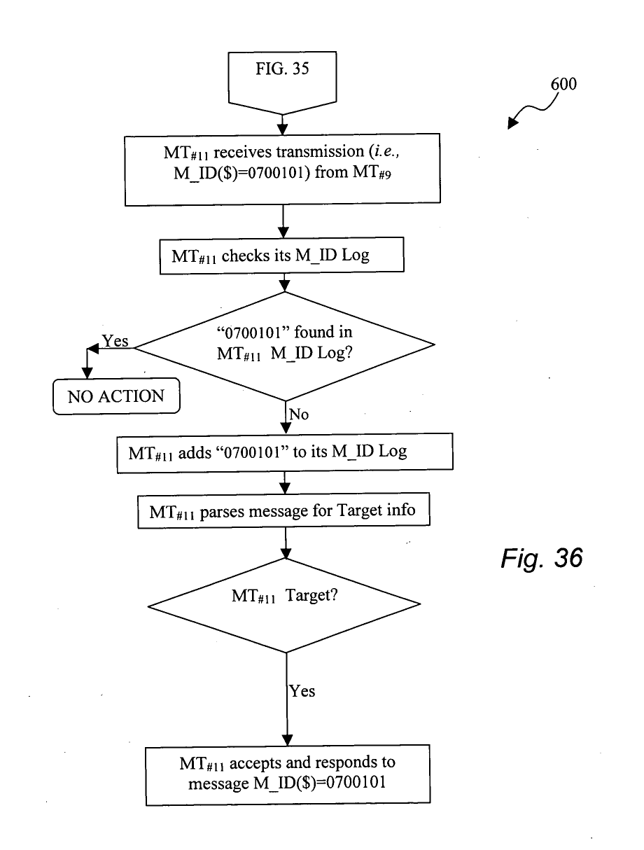

FIGS. 26 through 36 relate to Working Example #1. A SWAT police team 360 is composed of seven SWAT members SWAT₁ through SWAT₇ who respectively carry GBM enabled MTs: MT_{w}, MTₓ, MT_{y}, MT₁, MT₂, and MT₃ (see TABLE 1).

The IDs (i.e., identities) of the MTs 120 associated with SWAT team/group 360 can be stored or programmed into each MT 120 that form group 360. Thus, in Working Example #1, there were seven MTs 120 that formed group 360, and hence seven MT IDs that can be stored on the memory of each MT (MT_{w}, MTₓ, MT_{y}, MT₁, MT₂, and MT₃₎. Alternatively, a plurality of authorized MT IDs are stored on the memory of each MT 120, such that, if authorized MTs should wander into the group, they can automatically be included and used to route messages to target MTs.

TABLE 1

| | IDs of individual mobile |
|---|---|
| | Terminals (MTs 120) |
| Members of | respectively carried by |
| SWAT Team 360 | members of Team 360 |
| SWAT₁ | MT_{w} |
| SWAT₂ | MTₓ |
| SWAT₃ | MT_{y} |
| SWAT₄ | MT_{z} |
| SWAT₅ | MT₁ |
| SWAT₆ | MT₂ |
| SWAT₇ | MT₃ |

At any given moment in time, one or more of the seven member SWAT team members 360 can be moving relative to each other and relative to the terrain on which the team members 360 are located. Thus, as the individual SWAT team members move around, in synchrony with their SOWC enabled MTs 120 which they carry on their person, potential wireless networks form and disintegrate according to the relative location of each SWAT team member and local geographical features that can act as barriers to wireless communication.

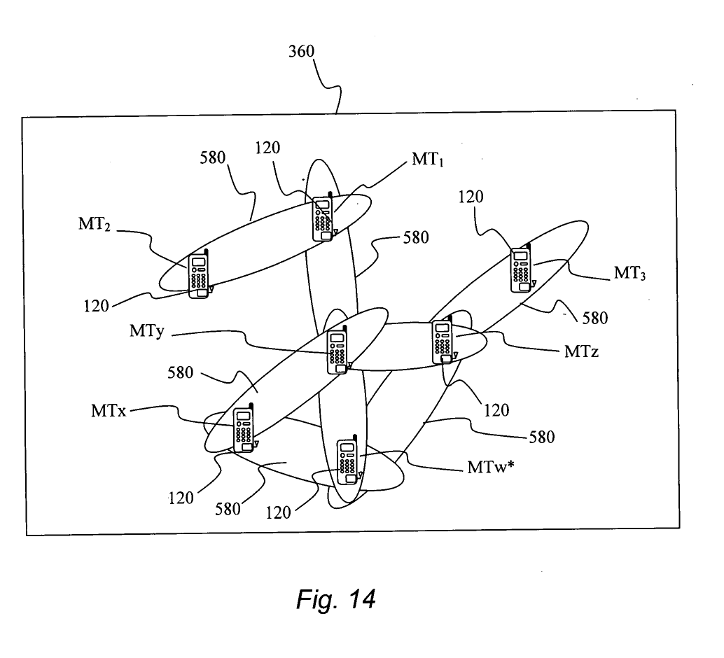

FIG. 14 shows the relative positions of a first plurality of team members 360. Each MT 120 (i.e., in this example, MT_{w} through to MT₃, see TABLE 1) at a given point in time creates a transceiver footprint or cell in which the MT can receive and transmit messages with other like MTs within its transceiver footprint. Overlapping cells are represented by numeric label “580”. The SOCC methodology establishes communication pathways to provide wireless communication between selected MTs, based on overlapping cells 580.

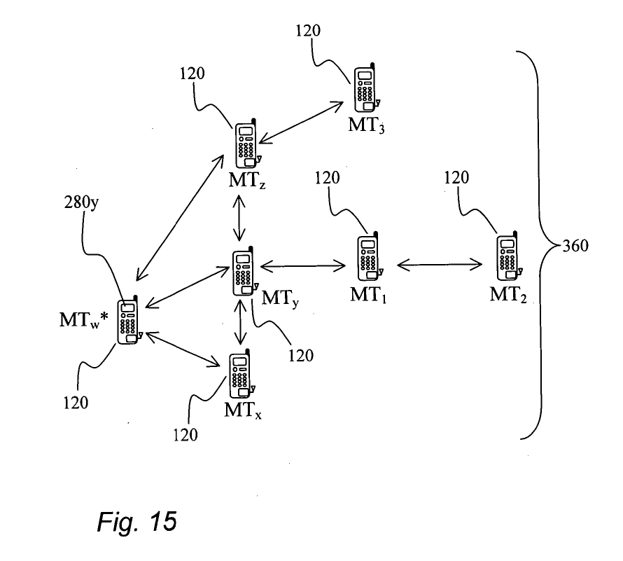

FIG. 15 shows the possible two-way wireless communications between MTs carried by team members 360. The alphanumeric label “280y” in FIG. 15 represents the display screen of MTw.

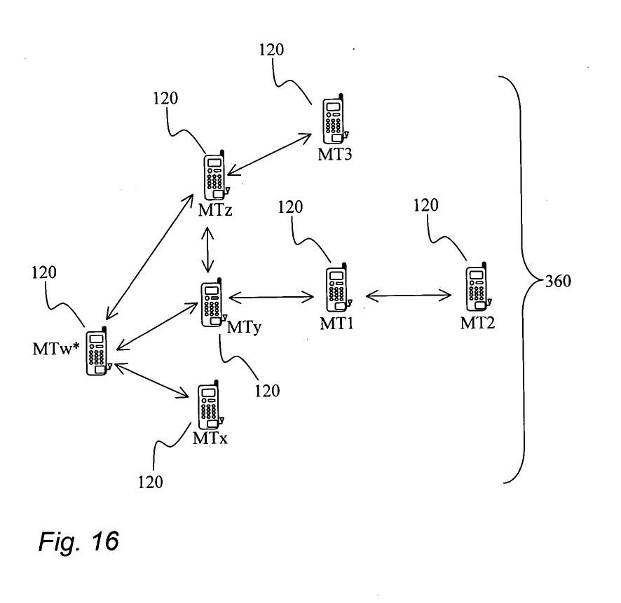

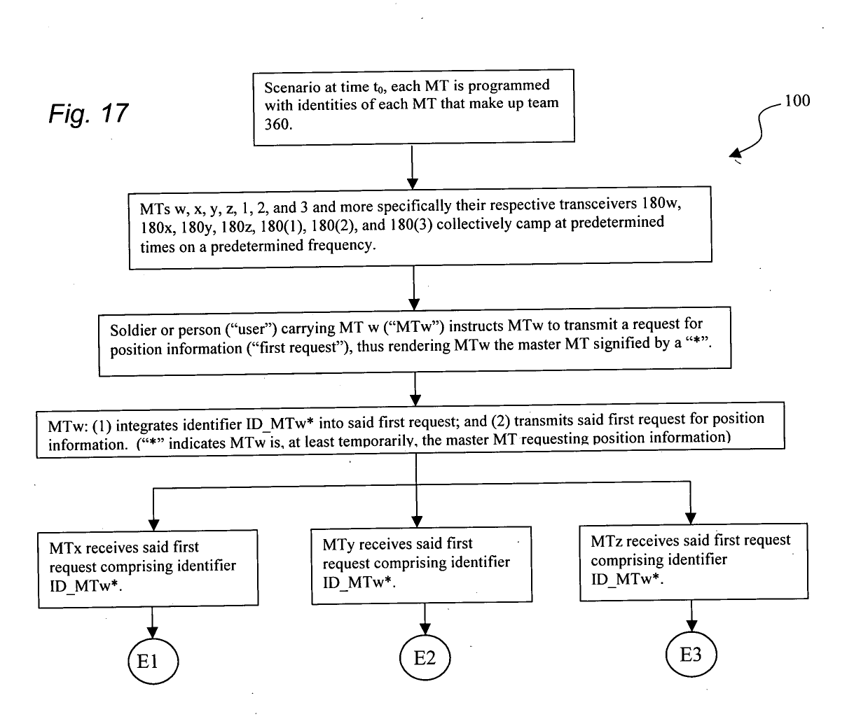

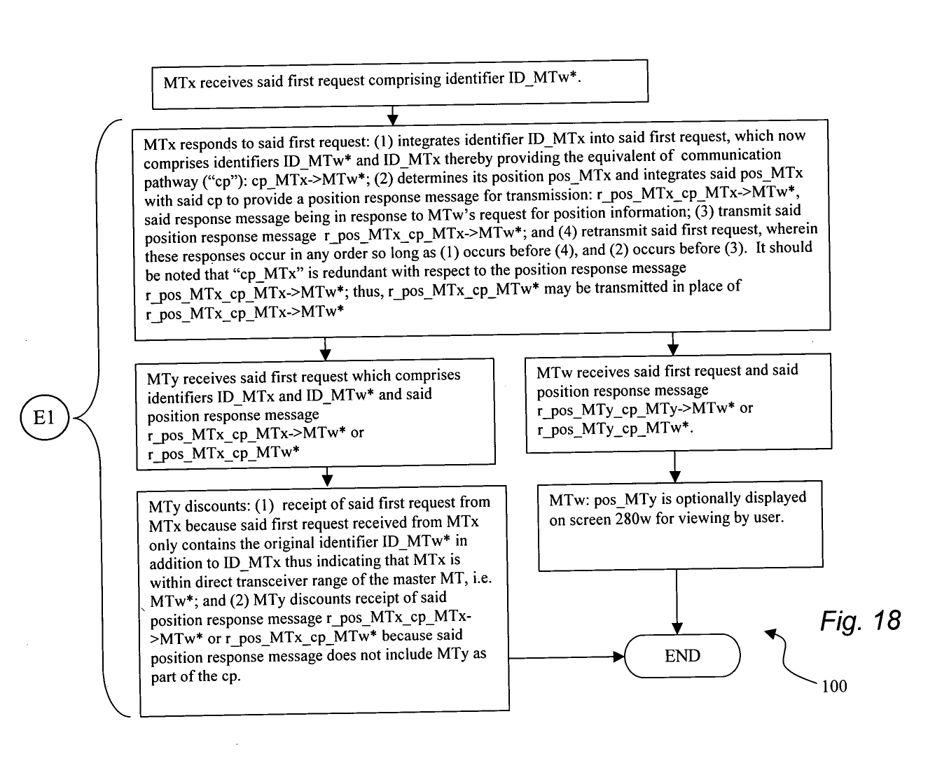

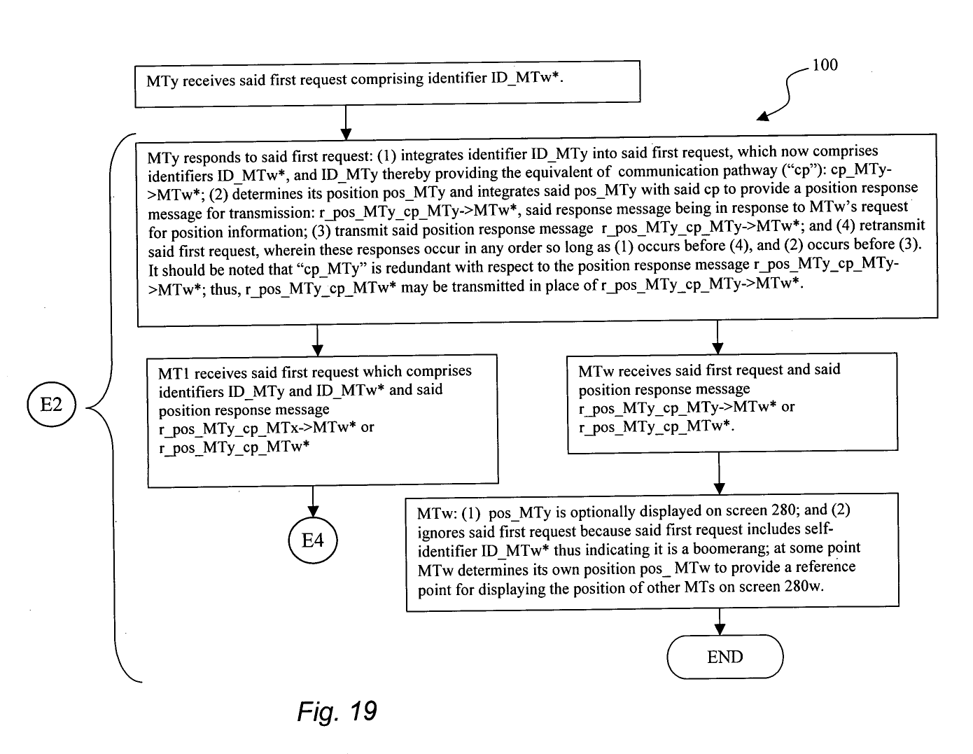

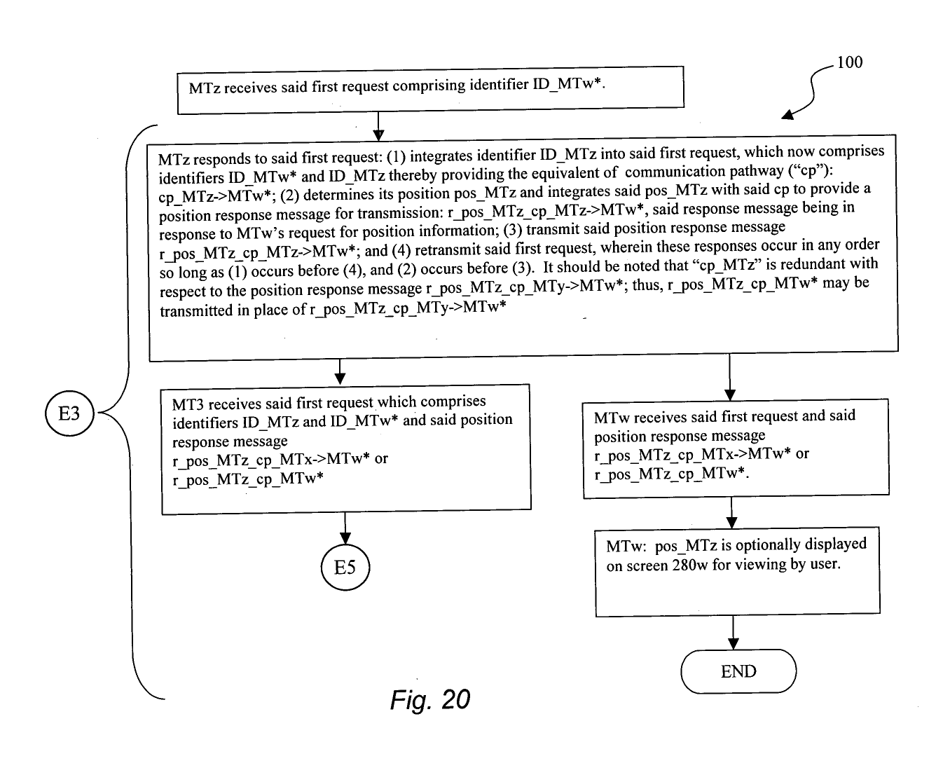

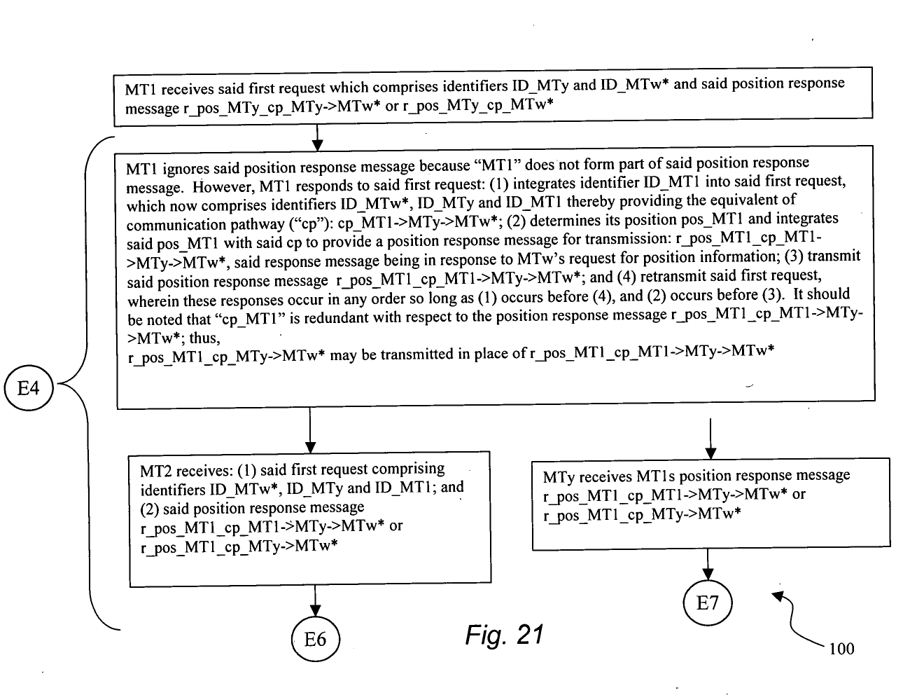

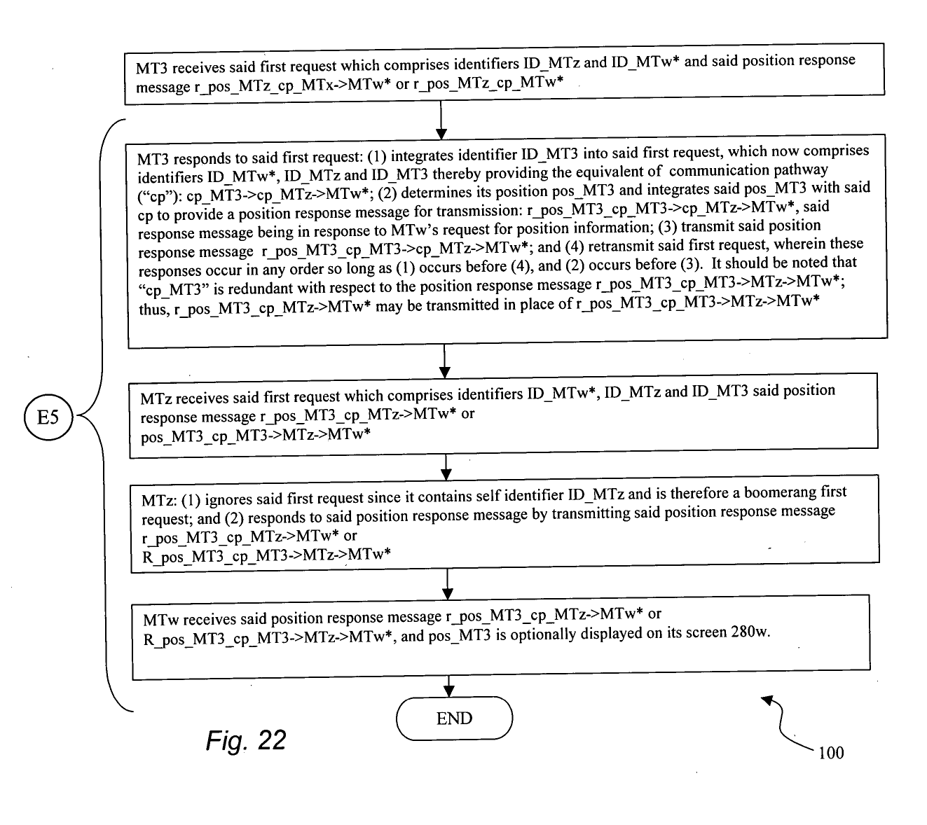

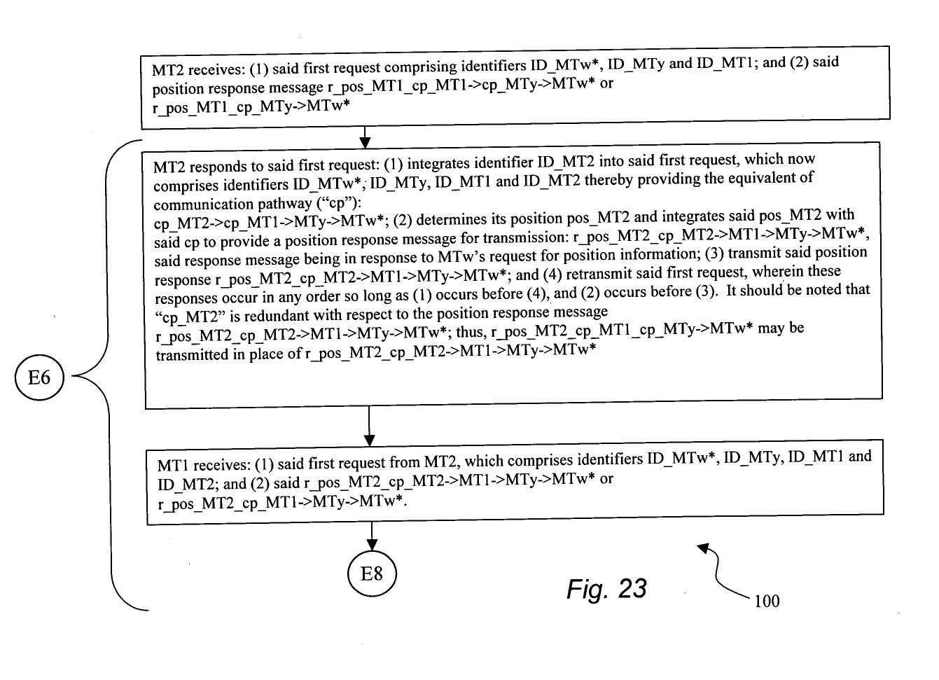

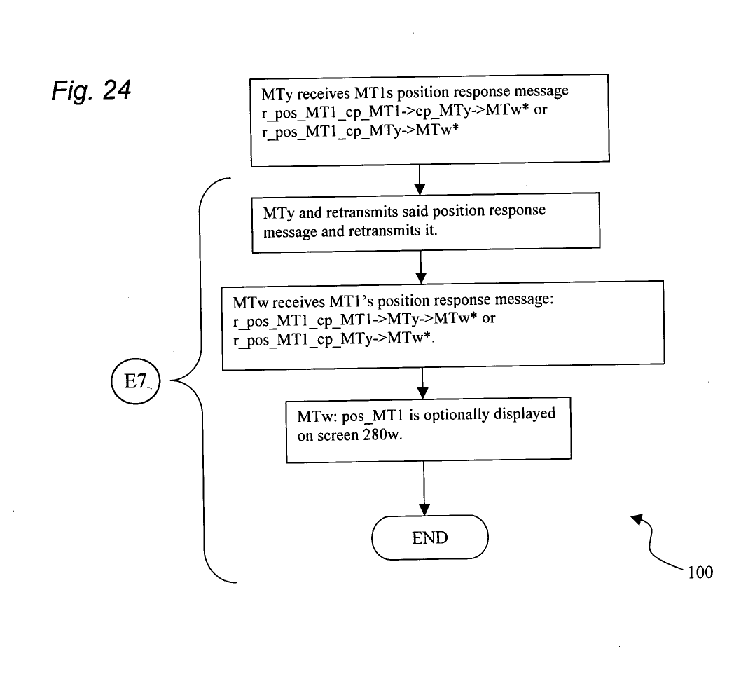

FIGS. 17-25 show a non-limiting example of the SOCC based wireless communication protocol 100 in action. As will be seen from the logic flow charts depicted in FIGS. 17-25, the SOCC protocol 100 is able to establish communication pathways between the MTs 120 carried by team members 360 to produce the actual communication pathways shown in FIG. 16.

TABLE 2
Transceiver Communication Table at Time t₀ (re: team members 360)

| | MTw* | MTx | MTy | MTz | MT1 | MT2 | MT3 |
|---|---|---|---|---|---|---|---|
| MTw* | — | 1 | 1 | 1 | 0 | 0 | 0 |
| MTx | 1 | — | 1 | 0 | 0 | 0 | 0 |
| MTy | 1 | 1 | — | 1 | 1 | 0 | 0 |
| MTz | 0 | 0 | 1 | — | 0 | 0 | 1 |
| MT1 | 0 | 0 | 1 | 0 | — | 1 | 0 |
| MT2 | 0 | 0 | 0 | 0 | 1 | — | 0 |
| MT3 | 0 | 0 | 0 | 1 | 0 | 0 | — |

Table 2 shows the available two-way communication links between the MTs within team member group 360. An asterisk “*” is appended to MT_{w} because the team member using MT_{w} has requested the positions of all the other team members in team member group 360. Specifically, binary “1” indicates respective MTs are within transceiver range of each other, whereas binary “0” indicates respective MTs are outside transceiver range of each other (e.g., MTₓ is within transceiver range of MT_{w}* and MT_{y} at time t₀, but is outside transceiver range of MT_{z}, MT₁, MT₂, and MT₃). In this example, team 360 are made up of SWAT personnel each carrying a SOCC enabled MT 120. Specifially, team 360 comprises seven people who separately carry one of the MTs: MT_{w}*, MTₓ, MT_{y}, MT_{z}, MT₁, MT₂, and MT₃. The “*” indicates that the human user carrying MTw has instructed MT_{w} to transmit a request for position information from all members of team 360. More specifically, “*” indicates MTw is the MT requesting information, in this example/scenario position information, but could be other forms of information such as health parameters of other team members 360. Thus, MT_{w} can be regarded, at least temporarily, as the master MT. FIG. 14 shows which MTs in team 360 are within transceiver range of each other.

Table 3 is a look-up table of logic rules that governs the flow of information within the SOCC methodology of the present invention. Specifically, each SOCC enabled MT in team member group 360 operates according to a plurality of router rules. The router rules are typically stored on memory inside housing 130 and are may read and processed by the processor 160 to enable the processor 160 to relay messages and/or data via transceiver section 180 to other MTs 120 in group 360.

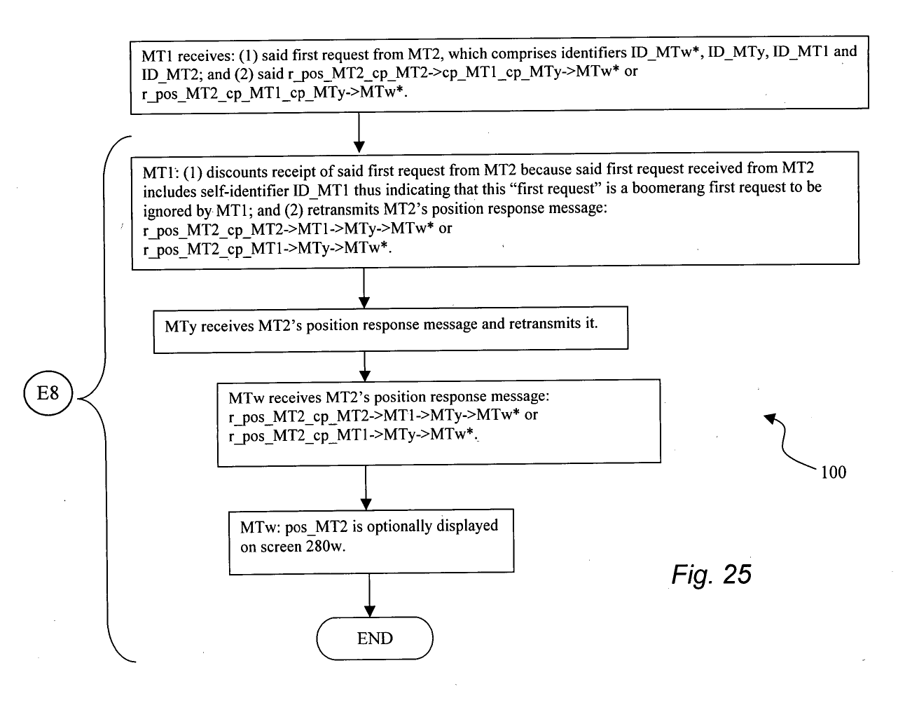

TABLE 3
Wireless router rules in the form of a look-up table for MTs 120 in
team 360, i.e., MTₓ, MT_{y}, MT_{z}, MT₁, MT₂, and MT₃

| Messages or Requests Received | |
|---|---|
| by SOCC enabled MTs of group | |
| 360 | Response |
| First request comprises identifier | MT$ parses said first request and ignores said first request |
| ID_MT$ and is received by | because said first request includes self-identifier ID_MT$; for |
| MT$ | example: MT1 discounts receipt of said first request from |
| | MT2 (see E8 section in FIG. 25) because said first |
| | request received from MT2 includes self-identifier ID_MT1 |
| | thus indicating that this “first request” is a boomerang first |
| | request to be ignored by MT1 |
| | (Note that “$” signifies an identifier.) |
| First request does not contain | MT$ appends identifier ID_MT$ into said first request and |
| identifier ID_MT$ and is | retransmits said first request unless MT$ also receives a |
| received by MT$ | position response message from the same source that does not |
| | include MT$ in said position response message in which case |
| | MT$ ignores said first request. |
| Position response message with | MT$$ ignores said position response message. |
| pos_M$ received by MT$$, | (Note that“$$” signifies second identifier) |
| wherein said position response | |
| message does not include | |
| “MT$$” | |
| Position response message with | MT$$ retransmits said position response message. |
| pos_M$ received by MT$$, | |
| wherein said position response | |
| message includes “MT$$” | |

FIGS. 17 through 25 show the SOCC protocol in action with respect to the MTs 120 of team 360 (i.e., MTₓ, MT_{y}, MT_{z}, MT₁, MT₂, and MT₃). The SWAT team member (“user”) carrying MT_{w} instructs MTw to transmit a request for position information (“first request”) to every team member in group 360. As a result, MT_{w} is rendered, for a time, the master MT signified by a “*”, i.e., MT_{w}*. The final outcome: the positions of MTₓ, MT_{y}, MT_{z}, MT₁, MT₂, and MT₃ are displayed on the screen 280y of MT_{w}.

### WORKING EXAMPLE #2

### NNM Protocol in Action

FIG. 26 shows the physical layout of a second plurality of MTs 120: MT#1 through to MT#12 (referred to collectively as team or group 590, see TABLE 4). Wireless communication barriers are shown in brick shading. Physical barriers that can weaken or otherwise attenuate radio waves include objects such as mountains and urban terrain (e.g., tall buildings). MTs 120 in Working Example #2 are NNM enabled.

TABLE 4

| | IDs of individual mobile Terminals (MTs 120) |
|---|---|
| Members of Team 590* | respectively carried by members of Team 590 |
| SOLDIER #1 | MT#1 (M_ID = 01)** |
| SOLDIER #2 | MT#2 (M_ID = 02) |
| SOLDIER #3 | MT#3 (M_ID = 03) |
| SOLDIER #4 | MT#4 (M_ID = 04) |
| SOLDIER #5 | MT#5 (M_ID = 05) |
| SOLDIER #6 | MT#6 (M_ID = 06) |
| SOLDIER #7 | MT#7 (M_ID = 07) |
| SOLDIER #8 | MT#8 (M_ID = 08) |
| SOLDIER #9 | MT#9 (M_ID = 09) |
| SOLDIER #10 | MT#10 (M_ID = 10) |
| SOLDIER #11 | MT#11 (M_ID = 11) |
| SOLDIER #12 | MT#12 (M_ID = 12) |
| *The members of team 590 can vary, for example, team 590 could be made up of firemen, earthquake rescue workers, disaster recovery teams, etc. The layout of members of team 590 at a given point in time is shown in FIG. 26. | |
| **M_ID (MT ID combined typically with Message ID, for example, for M_ID = 0900004, this indicates message #4 produced or originated from MT#9; and for M_ID = 1201091, this indicates message | |
| # #1091 produced or originated from MT#12. The number of digits in M_ID can vary; in this example the maximum number of MTs 120 (and hence soldiers with MTs 120) is 99 since there are two digits (the first two | |
| # digits) allocated for MT ID. Allocating a further digit will mean up to 999 MTs could enter the group 590. With respect to message ID, if 5 digits are allocated, then an MT can serially stamp up to 99999 messages for a particular mission and then the message ID count would | |
| # overrun and preferably restart at 00001, however, overruns are preferably to be avoided as they could crash the system. Thus, for longer missions or for missions where message traffic between MTs 120 within a team are likely to be high, the number of digits allocated to | |
| # serially stamping messages should be increased, this option could be set, for example, by the team's leader at the start of the mission. | |

The IDs (i.e., identities) of the MTs 120 associated with a particular group can be stored or programmed into each MT 120 in the specified group. Thus, in Working Example #2, twelve MTs 120 form part of the team or group and can be stored on each MT 120 in this group, wherein any messages received which are not associated with MTs of this group can be ignored. However, it is preferred that a plurality of authorized MT IDs is stored on the memory of each MT 120. Thus, if authorized MTs should wander into the group, then they can automatically be included. To this end the variable M_ID($) can be used (discussed in more details below), wherein a plurality of authorized MT IDs can be stored in memory on each MT 120; in addition, every message originating from an MT 120 in group 590 is preferably uniquely identifiable and tied to the originating MT. For example, M_ID($) could be used to identify the originating MT and the message number allocated in serial fashion by the originating MT. For example, in M_ID($)=070000101, the first two digits are used to identify the originating MT and the remaining digits the serial number of the message originating from the MT; thus, M_ID($)=070000101 signifies message #101 originated from MT#7, and M_ID($)=100006141 signifies message #6141 originated from MT#10. It would be understood that the exact way of identifying and tracking the originating MT and a particular message produced at a given time from the originating team can vary without detracting from the spirit of the present invention.

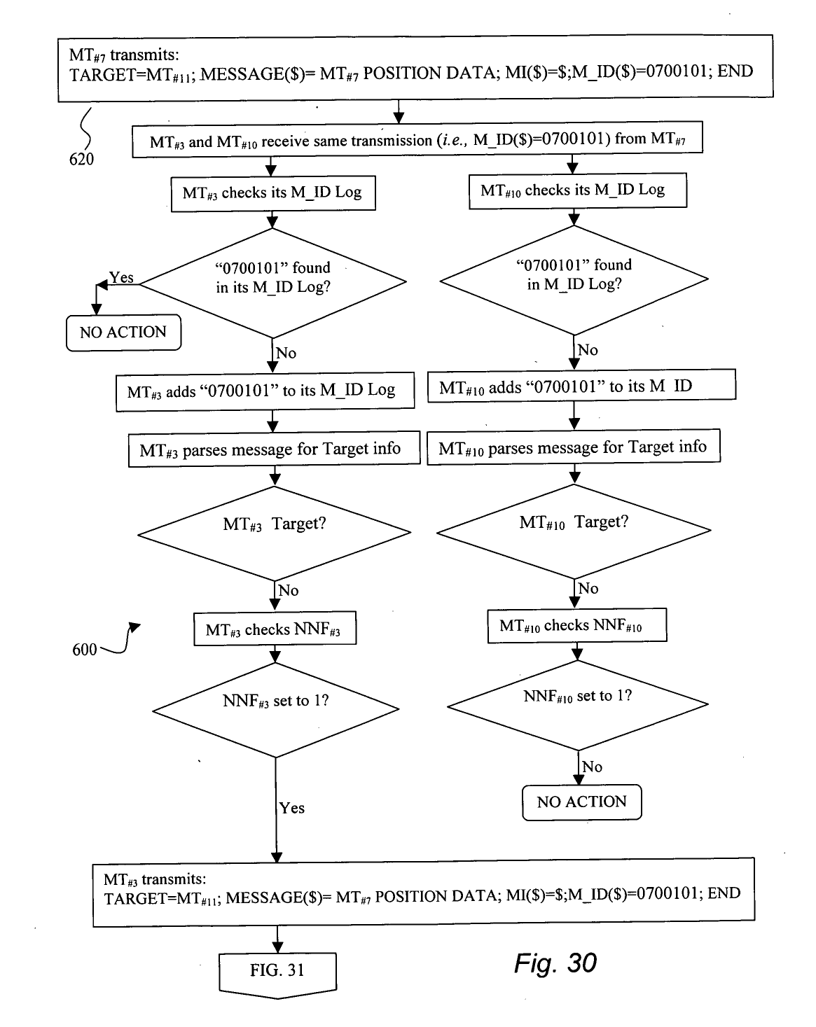

The use of the joint identifier M_ID($) (combining MT and message identifiers) helps quench, for example, boomerang messages, wherein if the same message comes back to an MT that has previously re-transmitted the same message, the same message is ignored thereby avoiding wasting system resources retransmitting redundant messages (i.e., messages already passed on). For example, if MT#5 received the same message with M_ID($)=070000012 at time t₁ and then again at time t_{1+y}, the message arriving at time t_{1+y} can be safely ignored. Also, if for example, MT#9 received back its own message, e.g., M_ID($)0900123, then MT#9 would know that it should ignore this message, that this message is a boomerang and can be safely ignored. This method of nullifying boomerang messages provides a useful way of quenching messages that would otherwise increase wireless communication overhead and possibly cause a network wide system crash. Use of M_ID($) is seen, e.g., in box 620 in FIG. 30, and is discussed in more detail below.

Though it is not explicitly shown in FIGS. 26-36, the M_IDs of MTs that wander into, or otherwise come into contact with, the group 590 should be verified as bona fide MTs and not unauthorized intruding MTs intended to infiltrate and illicitly gain intelligence (such as position information of legitimate MTs). Such a logic step would be invaluable if the NNM (or SOCC) based MTs 120 of the present invention were used by, for example, special forces troops or anti-terrorist personnel operating in hostile areas with unfriendly forces intent on capturing or harming team members, in this example, team members in group 590.

Communication pathways are established under the NNM protocol of the present invention by each MT determining its neighbors, not in terms of distance, but in terms of which other MTs 120 are within transceiver range. To this end, a nearest neighbor list (“NN list” or “NNL”) is compiled (see TABLE 4).

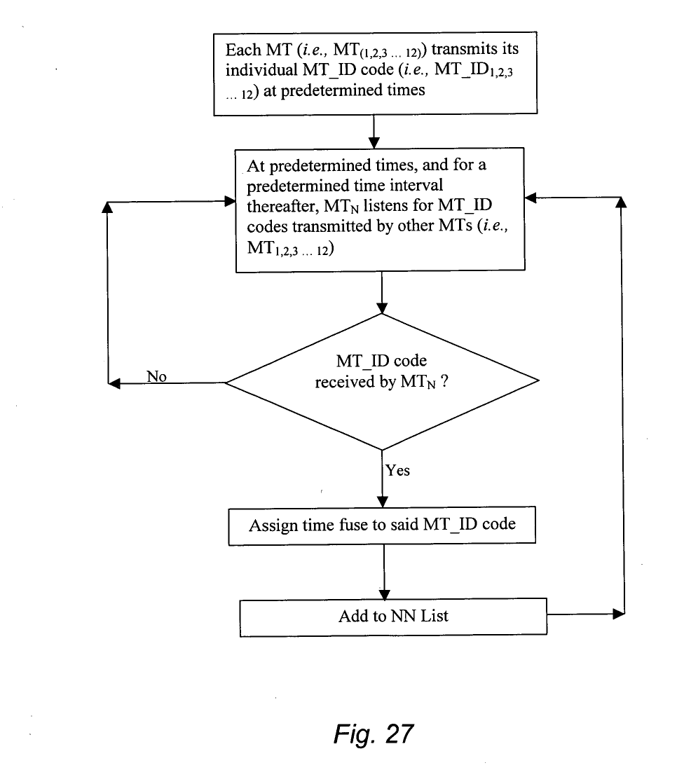

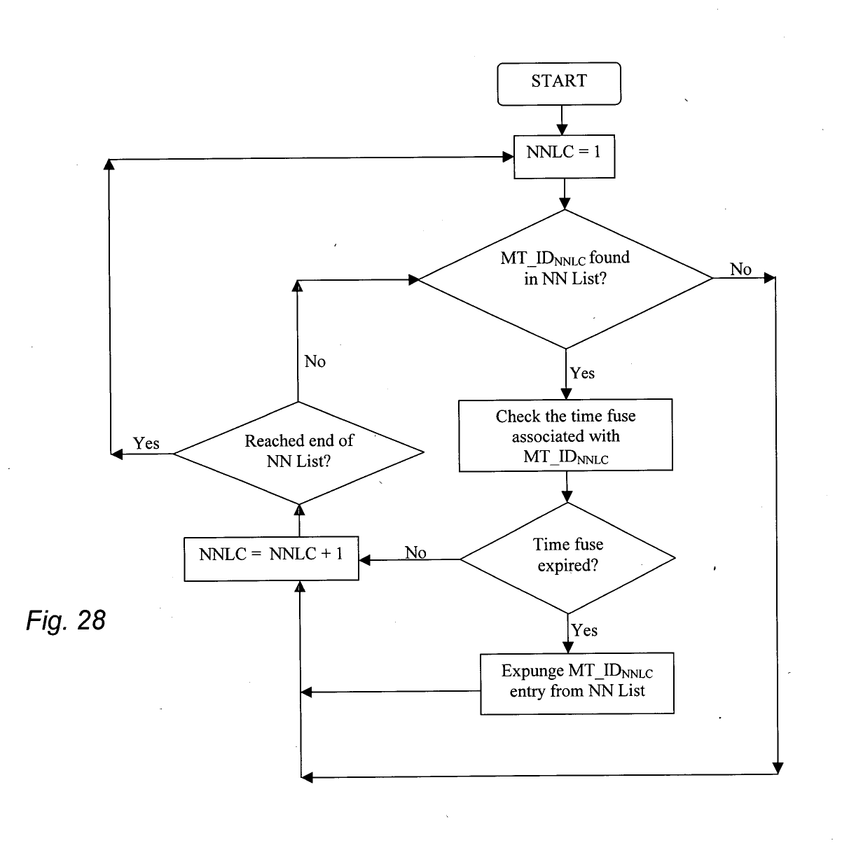

FIG. 27 shows how the NN list can be compiled with respect to each NNM enabled MT 120 of group 590. Each MT 120 compiles and stores its own NN list. When it is time to expunge or flush the NN list of a particular MT, the NN list is expunged as shown in FIG. 28, wherein “NNLC” is an integer variable “nearest neighbor list counter” for counting or working through each MT ID. The NN list for each MT can be triggered by a triggering event (e.g., a request from another MT to recompile a NN list) or at predetermined intervals, hence the reference to “time fuse” in FIGS. 27 and 28. Alternatively, a number of NN lists can be compiled and pushed onto a virtual memory stack using LIFO (last in, first out) methodology.

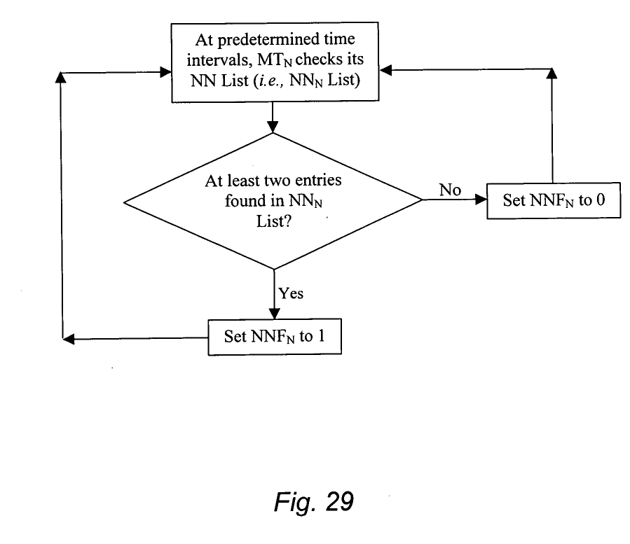

FIG. 29 shows how each MT 120 sets its nearest neighbor flag (NNF_{N}). For example, MT#1 would have its own nearest neighbor flag NNF₁, which can be set, for example, to binary zero or 1. A binary zero indicates that the corresponding MT does not have any nearest neighbors in its NN list. This is very significant, because there is no point in re-transmitting received messages if there is not a meaningful MT within transceiver range. The sending MT should be discounted, as it is the MT that sent or forwarded a message. For example, if MT#A received a message from MT#B, and only MT#B was in transceiver range of MT#A, then MT#B should not retransmit the message, this will avoid wasting power.

TABLE 4
Compilation of all Nearest Neighbor ((NN) Lists at Time T_{χ}

| | | | | | | | | | | | | |
|---|---|---|---|---|---|---|---|---|---|---|---|---|
| MT# | 1 | 2 | 3 | 4 | 5 | 6 | 7 | 8 | 9 | 10 | 11 | 12 |

| | | | | | | | | | | | | |
|---|---|---|---|---|---|---|---|---|---|---|---|---|
| 1 | | | | | | | | | | | | ✓ |
| 2 | | | | ✓ | | | | ✓ | ✓ | | | |
| 3 | | | | | | | ✓ | | | | | ✓ |
| 4 | | ✓ | | | | | | | ✓ | | | |
| 5 | | | | | | | | ✓ | | | | ✓ |
| 6 | | | | | | | | | | | | ✓ |
| 7 | | | ✓ | | | | | | | ✓ | | |
| 8 | | ✓ | | | ✓ | | | | | | | |
| 9 | | ✓ | | ✓ | | | | | | | ✓ | |
| 10 | | | | | | | ✓ | | | | | |
| 11 | | | | | | | | | ✓ | | | |
| 12 | ✓ | | ✓ | | ✓ | ✓ | | | | | | |

Key:
✓ = transceiver (i.e., two-way) communication between mobile terminals (in this example, MT_{#2} is within transceiver range of MT_{#4}, MT_{#8} and MT_{#9}).

FIGS. 30-36 show a non-limiting example of the NNM based wireless communication system 600 in action. Specifically, In FIG. 30, MT_{#7} wirelessly transmits a message at 620, wherein the message at 620 comprises the string: “TARGET=MT_{#11}; MESSAGE($)=MT_{#7} POSITION DATA; MI($)=$; M_ID($)=007−0000101; END”. The message portion that recites: “TARGET=MT_{#11}” indicates that the target MT is MT_{#11}. The message portion that recites “MESSAGE($)=MT_{#7} POSITION DATA” indicates that the message contains the position coordinates for MT_{#7}, i.e., MT_{#7} is reporting its position to MT_{#11}. MT_{#7} might be responding to an earlier request sent by MT_{#11} to MT_{#7}. Alternatively, MT_{#7} might be reporting its position to MT_{#11} at predetermined periodic intervals. Obviously, the MESSAGE($) portion can be used for any kind of data request for more data. For example, “MESSAGE($)=Return POSITION DATA” would in the context of the message string in block 620 of FIG. 30 be a request for MT#11 to transmit its position to MT#7, albeit using the NNL based communication protocol 600.

The message portion that recites, “M_ID($)=0700101” speaks to the message identity. Specifically, before each message is transmitted, a unique messenger identifier is encoded into the message, i.e., “M_ID”. The first two digits of M_ID are reserved, in this example, for the identity of the MT that originated the message. Specifically, “07” indicates that MT#7 is the originator of the message. The next six digits of M_ID is reserved to identify the number of the message, hence this is the 101^{st} message originating from MT#7. That is, MT#7 counts in serial fashion all its outgoing original messages. Thus, any MT in team 590 merely receiving and retransmitting a received message, this outgoing message is not tagged with a number. Thus, MTs act as repeaters unless they are producing an original message, in which case the other MTs in the group 590 act as faithful repeaters.

It is to be understood that the present invention is not limited to the embodiments described above, but includes all equivalents thereof available under the doctrine of equivalence.

We claim:

1. In a wireless radio network system comprising a plurality of mobile terminals, a method for facilitating communication between said mobile terminals, comprising the steps of:
scanning for wireless broadcasts, wherein said scanning is performed by said mobile terminals to identify neighboring mobile terminals within transceiver range of each other;
establishing a plurality of nearest neighbor lists, wherein one or more of said mobile terminals establish their own nearest neighbor list;
compiling wireless possible communication pathways based on said nearest neighbor lists; and
sending wireless messages via said communication pathways.

2. In a wireless radio network system comprising a plurality of mobile terminals, a method for facilitating communication between said mobile terminals, comprising the steps of:
broadcasting at least one wireless message, said at least one wireless message containing information identifying an originating mobile terminal that originated said at least one wireless message and the mobile terminal which is a target of said wireless message; and
retransmitting said wireless message between said mobile terminals until said at least one wireless message is received by said target mobile terminal.

3. A mobile terminal capable of wireless communication, said mobile terminal comprising:
a transceiver;
a power source;
a processor; and
a memory, wherein said memory includes code to perform wireless communication by means of the SOCC protocol.

4. The mobile terminal according to claim 3, further comprising an information generating system 140.

5. The mobile terminal according to claim 3, further comprising an information generating system 140, wherein the information generating system 140 is a GPS receiver 200.

6. The mobile terminal according to claim 3, further comprising an information generating system 140, wherein the information generating system 140 is a GPS receiver 200 in combination with a bio-monitor 187.

7. The mobile terminal according to claim 3, further comprising an information generating system, wherein the information generating system is a GPS receiver in combination with a bio-monitor, wherein the bio-monitor is a pulse oximeter.

8. A mobile terminal capable of wireless communication, said mobile terminal comprising:
a transceiver;
a power source;
a processor;
a memory, wherein said memory includes code to perform wireless communication by means of the NNM protocol.

9. The mobile terminal according to claim 8, further comprising an information generating system 140.

10. The mobile terminal according to claim 8, further comprising an information generating system 140, wherein the information generating system 140 is a GPS receiver 200.

11. The mobile terminal according to claim 8, further comprising an information generating system 140, wherein the information generating system 140 is a GPS receiver 200 in combination with a bio-monitor 187.

12. The mobile terminal according to claim 8, further comprising an information generating system, wherein the information generating system is a GPS receiver in combination with a bio-monitor, wherein the bio-monitor is a pulse oximeter.
